(19) United States
(12) Patent Application Publication
(10) Pub. No.: US 2024/0296378 A1
(43) Pub. Date: Sep. 5, 2024

(54) ELECTRIC VEHICLE DETECTION

(71) Applicant: Weave Grid, Inc., San Francisco, CA (US)

(72) Inventors: Mark Henle, Berkeley, CA (US); Burton DeWilde, Burlington, VT (US); Kira G. Olsen, Bend, OR (US); Rohith Desikan, San Francisco, CA (US); Stephan Ellner, Oakland, CA (US); Apoorv Bhargava, San Francisco, CA (US); John Marshall Taggart, San Francisco, CA (US)

(73) Assignee: Weave Grid, Inc., San Francisco, CA (US)

(21) Appl. No.: 18/177,052

(22) Filed: Mar. 1, 2023

(51) Int. Cl. G06N 20/00

(52) U.S. Cl. CPC G06N 20/00

(57) ABSTRACT

Techniques are presented for the detection of whether an EV is using a household or other user location for charging. A machine learning model is trained on a training population of user locations using historical usage data and a label for a some of the user locations, typically a small proportion, indicating that an EV charges there, where the labels can, for example, be provided by a utility or derived from the EVs' telematics. The trained model can then be applied to un-labeled user locations' electricity usage data to detect EV charging, both assigning a label and a confidence value to the label. If telematics are available, for user locations at which EV charging is detected, the EV charging can be disaggregated from other electricity usage of the user location.

### BACKGROUND

Electrical power is provided from generation sources over transmission lines to substations, where the voltage levels are stepped down and the electricity supplied to customers over localized distribution networks. In a typical low voltage local distribution network, multiple customers are supplied from a single transformer. Such transformers will commonly have a maximum amount of power or current that they can provide before they degrade or fail. Consequently, if multiple customers commonly supplied from a single transformer all draw large amounts of power at the same time, the transformer can be damaged or fail. With the increased popularity of electric vehicles (EVs), such a situation is becoming increasingly common as the recharging of EVs draws relatively large amounts of power and customers will often charge their EVs at nighttime when they return home. This can place the local distribution network supplying these vehicles under excessive strain.

### BRIEF DESCRIPTION OF THE DRAWING

Like-numbered elements refer to common components in the different figures.

FIG. 1 is a high-level diagram of an electric power distribution system.

FIG. 2 shows an example of a low voltage distribution network serving multiple customers at which electric vehicles (EVs) are charged.

FIG. 3 is graph of time of day versus power for a set of homes sharing a common distribution transformer and where a number of EVs are charged in an uncoordinated manner.

FIG. 4 is graph of time of day versus power for a set of homes sharing a common distribution transformer and where a number of EVs are charged in a coordinated manner.

FIG. 5 is graph of time of day versus power for a set of homes sharing a common distribution transformer and where a number of EVs are charged in a coordinated manner that takes advantage of time of use discount rates.

FIG. 6 is a high-level representation of some of the elements that can go into one embodiment for the optimizing of the charging of EVs over distribution networks.

FIG. 7 is a table illustrating examples of service account data that can be provided from a utility to the load manager.

FIG. 8 is a table to illustrate components that can be used in embodiments of algorithms for the load manager's control software to schedule charging to minimize stress on constrained system components such as transformers, while enabling overall higher asset utilization.

FIG. 9 is a schematic representation of an embodiment for the technology platform for implementation of the load manager.

FIG. 10 is a flowchart of an embodiment for the registration and monitoring of EV data.

FIG. 11 is a flowchart for one embodiment of a method for optimizing EV charging schedule without energy export.

FIG. 12 is a is a flowchart for one embodiment of a method for optimizing EV charging schedule with energy export.

FIG. 13 illustrates an embodiment of a flowchart for a schedule optimization flow to generate asset-productive joint EV charging schedules.

FIG. 14 is a schematic representation an embodiment for the dataflow between some of the services in the flows of FIGS. 10-13 and the load manager's storage.

FIG. 15 is a high-level block diagram of a computing system that can be used to implement various embodiments of the load manager application of FIG. 9.

FIGS. 16A-16C provide several examples of a customer location's electricity usage over a multi-week time interval, for both locations where an EV is charged and is not charged.

FIG. 17 is a flowchart of an embodiment for EV detection.

FIG. 18 illustrates the relationship between different parts of an embodiment of the EV detection application.

FIG. 19 provides more detail on an embodiment for the model architecture and its features.

FIG. 20 illustrates model performance based on precision, recall, and a combination of these.

FIG. 21 is histogram of the of predictions for a given prediction probability.

### DETAILED DESCRIPTION

The following presents techniques for scheduling the charging of electric vehicles (EVs) that protect the resources of local low voltage distribution networks. Data on the local low voltage distribution networks, such as the rating of a distribution transformer through which a group of EVs are supplied, is provided from utilities to a load manager application. Telematics information on vehicle usage is provided from the EVs, such as by way of the original equipment manufacturers for the EVs. From the telematics data and the data from the utilities, the load manager application determines schedules for charging a group of EVs through a shared low voltage distribution network so that the capabilities of the local low voltage distribution network are not exceeded while meeting the needs of the EV users. Charging schedules are then transmitted to the on-board control systems of the EVs.

In other aspects, techniques are presented for the detection of whether an EV is charging at a household or other customer location A machine learning model is trained on a population of customer locations using historical usage data and a label for some of the customer locations, typically a small proportion, indicating that an EV charges there, where the labels can, for example, be provided by a utility or derived from the EVs' telematics. The trained model can then be applied to un-labeled customer locations' electricity usage data to detect EV charging, both assigning a label and a confidence value to the label.

Additional aspects allow for the EV charging to be disaggregated from other electricity usage of a customer location. If telematics are available for an EV at a charging location, disaggregated EV charging energy consumption can be used to improve the quality of charging energy consumption data obtained by telematics alone, where this data can be combined with AMI data to more accurately extract values for the EV energy consumption. In some embodiments, telematics data can be used to train the EV detection model and then used on households where telematics data is unavailable, where the model can predict the detection of an EV, when it is charging, and how much energy it consumed.

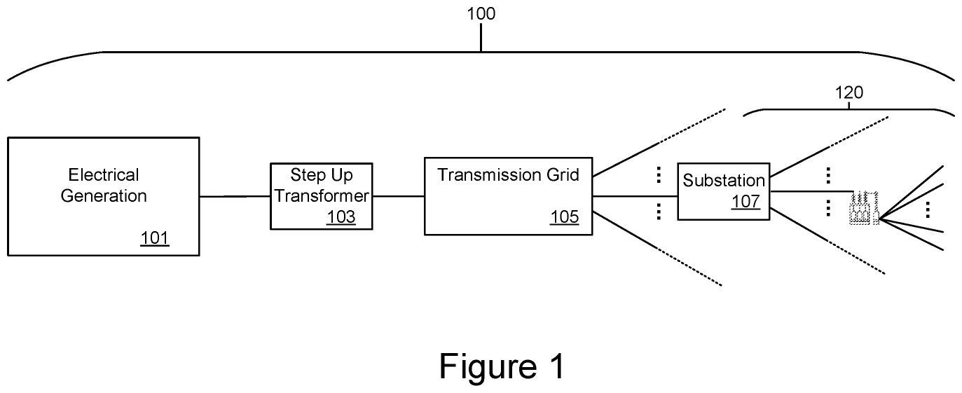

FIG. 1 is a high-level diagram of an electric power distribution system for a power grid 100. At the electrical generation block 101, one or more power plants or other generation sources generate the electricity. The electrical generation sources can include large scale power plants, such as gas or coal fired power plants, nuclear power plants, wind or solar power generator, hydro-electric power generation, or other forms of power plants. An electrical grid will typically include a number of such power plants. The electricity will be distributed to customers over a transmission grid 105 formed of transmission lines that can carry the electricity over long distances. The transmission lines typically carry the electricity as high or very high voltage alternating current (AC). Such transmission lines commonly carry voltage levels of hundreds of kilovolts. The electricity from a power plant 101 will often be supplied to the transmission grid 105 by way of step up transformer 103 that steps up the voltage to the high-voltage levels used by the transmission grid.

To supply customers, the high-voltages levels (˜100 s kV) on the transmission lines are received at substations 107, where the voltage is stepped down to the low voltage range of hundreds to a few thousand volts. The stepped down voltage is supplied to a local, low-voltage distribution network 120 serving customers. The distribution lines carry the electricity to distribution transforms that will usually supply a number of customs and further steps-down the voltage to the levels used by the end customer, usually in the 100-200 volt range.

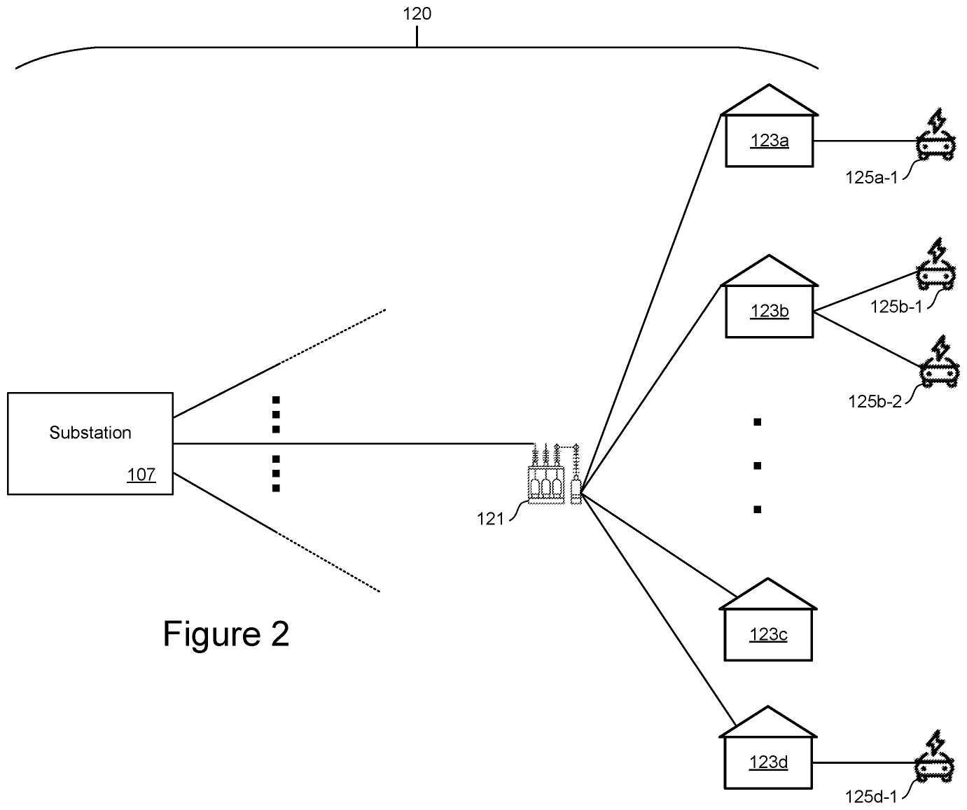

FIG. 2 shows an example of a low voltage distribution network 120 serving multiple customers at which electric vehicles (EVs) are regularly charged. After the voltage level is stepped down to the distribution voltage level at a substation 107, it is supplied to the local distribution network at a voltage less than used on the transmission grid, but usually higher than used by the customer. For example, typical residential customer will use voltages in the 100-240V ranges, while the substation supplies the distribution network 120 at voltages in the range of several thousand voltages. The specifics of the distribution can vary with respect to region and with respect to individual topologies and components of a given distribution network within a region. Generally, the network will have one or more main branches that will in turn branch several more times. For supplying customers from these branches, distribution transformers 121 will step the voltage down to the level or levels used at the customer level, here the four residences 123a, 123b, 123c, and 123d, but, more generally, the number can range one to many more. In a common residential setting, the distribution transfer will commonly be a pole mounted transformer that feeds a group of houses.

All of the electricity provided to the group of houses (or other set of customers) 123a, 123b, 123c, and 123d is provided through the single transformer 121. Distribution transformers have ratings specifying the amount of electricity that they can provide without damage, where distribution transformers normally have ratings less than 200 kVA, where a volt-ampere (VA) is the unit used for the apparent power that a transformer can safely provide. If a distribution transformer is supplying at a level that exceeds this rating, it may degrade or fail. In some cases, a distribution transformer can handle an among of power exceeding the specified rating by some amount for a short time, but repeated or extended calls on a transfer to exceed its nominal specified rating will eventually lead a transformed to degrade or fail. Distribution transformers may also degrade over time even when operated within the nominal rating specification, so that the actual maximum apparent power that can safely be provided through a distribution transform be less than specified. The following discussion will mainly focus on the distribution transformers, but other upstream elements of the distribution network 120, such as feeders and substations, can also be taken into account in the detennination of the EV charging schedules.

A local distribution network is typically laid out so the that maximum expected power drawn by a group of houses or other customers is within the corresponding distribution transformer's rating, usually with some amount of headroom to avoid overtaxing the distribution transformer. However, these determinations have often been made quite some time in the past based on expected loads. As equipment ages and degrades, and customers often add on additional electronic appliances and other equipment, the overhead margin can diminish and the demands on a distribution transformed may be near or exceeding its rating. The introduction of electric vehicles, or EVs, has aggravated this situation.

The amount of power drawn by an electrical vehicle while being charged can be significant. The owner of an electric vehicle will typically do most, if not all, of the charging for the EV at home. The amount of power drawn by an EV being charged will often be more than the combined power drawn by all other electronic power drawn by the residence. FIG. 2 illustrates the situation where the shown residences have several EV, EV 125a-1 at 123a, 125b-1 and 125b-2 at 123b, and 125d-1 at 123d. A common time for charging an EV is when the owner returns home in the evening, staring the process before going to bed for the night. If each of these EVs in FIG. 2 is charging concurrently, the amount of power being drawn can quite easily exceed the rating of the distribution transformer, perhaps significantly so.

It should be noted that this problem is concentrated in the final portions the distribution grid, at the distribution transformer 121 and other elements of the local distribution network 120. Since this spiking due to EV changing will typically occur at night, when industrial and commercial power demand is low, the power provided from the electrical generation block 101 and the capabilities in power generation block 101 and the transmission grid 105 up to the substations 107 may be more than up to the requirements, but the distribution network 120, and the distribution transformers 121 in particular, cannot meet the demand. With the increased usage of EVs, it is the distribution grid where rapid evolution of needs is happening, segment of the power distribution system that is the most aged and has the least visibility.

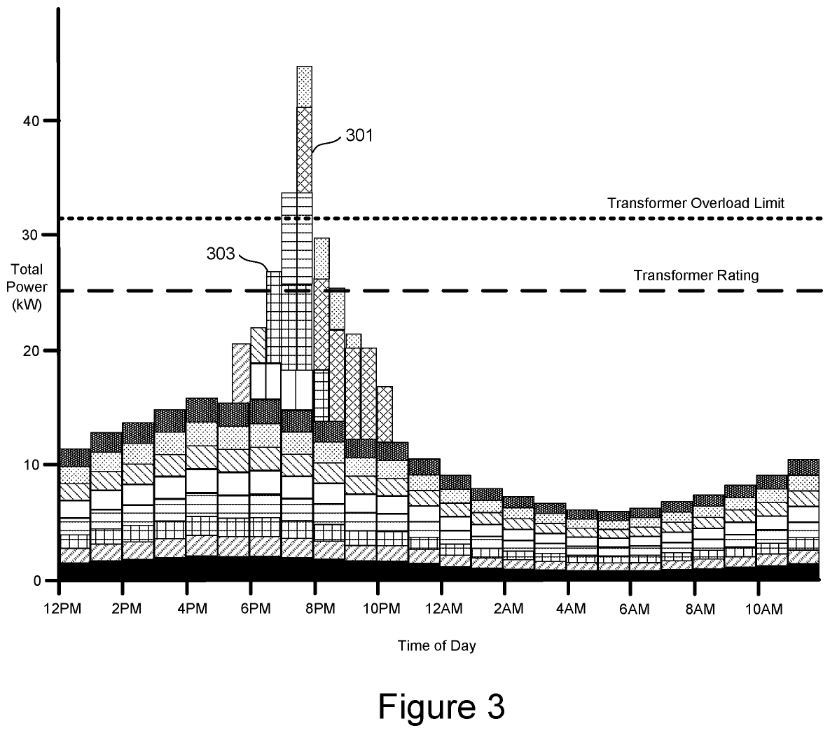

FIG. 3 is graph of time of day versus power for a set of homes sharing a common distribution transformer and where a number of EVs are charged in an uncoordinated manner. In the example of FIG. 3, the power consumption of a set of seven houses from noon of one day to noon of the following day is shown on an hour by hour basis. The curving lines along the bottom represent examples of typical usages in kilowatts (kW) of the set of houses without the inclusion of EV charging.

Also on the graph of FIG. 3 is marked the rating for the distribution transformer, which is set at 25 kVA in this example and which is a fairly typical value. The rating represents the level for which a transfer is designed to operate for an extended period. Also shown is an overload limit for the distribution transformer, which is a higher value (32 kVA in this example) that a distribution transformer may be able sustain for brief intervals. Exceeding these limits can cause the distribution network to degrade or fail at once. For example, a particularly large spike could lead to a catastrophic failure. A lower spike, while not leading to a sudden failure, might cause the transformer oil or other insulating liquid to boil, degrading the transformer. As shown in FIG. 3, the combined, non-EV usage of the set of residences is well within the distribution transformer's rating; however, in many cases the actual rating of a transformer may not be known, either through lack of records or device aging.

FIG. 3 also shows the addition electrical use for the set of houses when several of the houses charge one or more EVs. In a typical usage model, as an owner returns home in the evening, they will plug in their EV to charge for several hours. The amount of power drawn, and the time for charging, will vary depending on the vehicle and its battery charge. Usually, charging will take several hours and the power drawn by a single EV will often exceed the total power used by the combined usage of the rest of the residence. Consequently, as the owners return home and begin charging their EVs, the total power being drawn can readily exceed the distribution transformer's rating and overload limit. As EVs become increasingly common, this situation will only worsen.

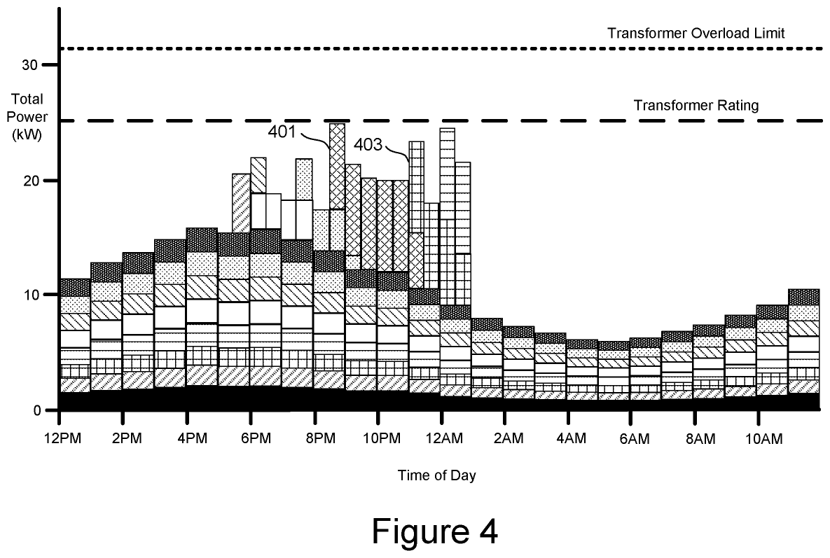

To avoid this situation, the following presents techniques to optimize the charging of electrical vehicle over a distribution grid so as to keep the demands on the distribution grid within its limitations. As described in more detail in the following discussion, information on the customers' power usage, details of the distribution network (such network topology and equipment specifics), information on vehicle usage (such as battery state and vehicle usage from telemetry data), and other factors can be used to instruct the EVs on scheduling and coordination of their charging. FIG. 4 illustrates the result of a such a coordinated charging.

FIG. 4 is graph of time of day versus power for a set of homes sharing a common distribution transformer and where a number of EVs are charged in a coordinated manner. FIG. 4 repeats the elements of FIG. 3, but now the charging of the EVs are coordinated so that the combined total power remains within the distribution transformer's rating. For any EVs that charge through the common distribution transformer, but are not registered with the load manager, their usage will be included with the base line usage. Although the EV may be hooked up for charging at the same time as for FIG. 3, based on the instructions received at the EV, an EV may delay its charging or charge at a lower rate. For example, rather than the EV indicated at 301 staring at 6:30 PM as indicated in FIG. 3, the charging in delayed to 8:30 PM as indicated at 401 of FIG. 4, so that when it is added in to the total drawn on the distribution transformer will be within its rating. Similarly, although the EV whose charging is indicated at 303 of FIG. 3 may still be connected for charging at 7:30 PM, it will delay its charging until 11:00 as indicated at 403 of FIG. 4. As illustrated in FIG. 4, this results in no overload time and, in particular, no extended overload.

In addition to considering peaking issues at the local distribution network, larger system level power network consideration can also be incorporated. For example, power networks may introduce time of use (TOC) pricing, introducing time of use discounting where rates are reduced during times when the total power consumption of the electric grid is lower. For example, late at night industrial and commercial usage will typically be lower. To have a more uniform demand on the power plants of the electrical generation block 101, discounts may be often to residential customers to incentivize late night usage.

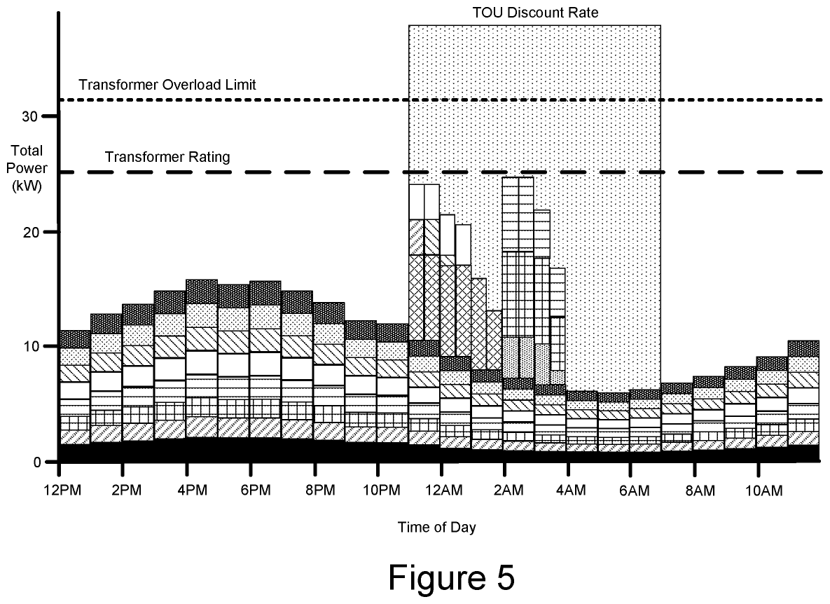

FIG. 5 is graph of time of day versus power for a set of homes sharing a common distribution transformer and where a number of EVs are charged in a coordinated manner that takes advantage of time of use discount rates. As illustrated in FIG. 5, all of the EVs delay their charging until the period of the TOU discount rate. The EVs can again be instructed to coordinate their charging to avoid overloading the local distribution transformer, but the arrangement of the charging times may differ relative to FIG. 4 as the other usage of the residences is reduced at these hours.

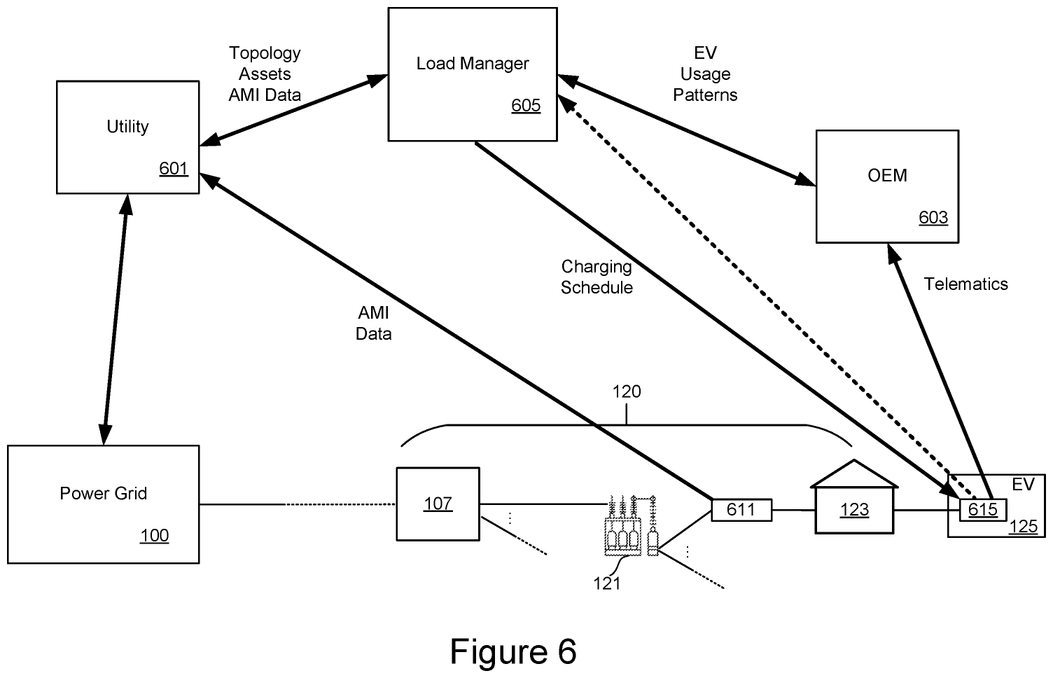

FIG. 6 is a high-level representation of some of the elements that can go into one embodiment for the optimizing of the charging of EVs over distribution networks. As in FIGS. 1 and 2, a power grid 100 supplies a residence or other customer 123 and which an EV 125 is charged, where only a single representative customer and EV is shown. Of the power grid 100, only one substation 107 and one distribution transformer 121 are explicitly shown. The power grid 100 is operated by one or more distribution utilities or other power providing entity, represented as utility 601. The utility 601 will have information on the power grid 100, including information such as the power grid's topology and of the assets forming the grid. For example, the utility will commonly have information on the local distribution grids such as the number of customers (such as 123) connected to a given distribution transformer 121, along with the rating and other information on the distribution transformer 121 and other elements of the local distribution grid 120, although this information may not be current. The customer 123 will often have its usage monitored by a smart meter 611 (Advanced Metering Infrastructure, or AMI), where this information is periodically sent to the utility 601. (The other customers of FIG. 2 can similarly have a corresponding smart meter.) The AMI will commonly contain not just total usage, but usage as a function of time, since rates may be time dependent such as for given time of use discounting. Consequently, the utility 601 will often have relatively detailed information on usage patterns of individual customers.

An EV 125 will include have on-board control systems 615 that monitor telematics for the EV. These telematics can vary from one EV original equipment manufacturer (OEM) to another, and from model to model of the same manufacturer (for example, a truck may track different telematics than a personal automobile), but will include information such as battery charge state, usage and location information. In addition to using these data for monitoring and controlling the EVs' operation, the telematics can be used to extract usage patterns. These telematics can be, and typically are, provided to an EV's OEM 603, and these telematics can be used to extract these usage patterns.

Based on the information form the utility 601 on the power grid 100, and in particular on the local distribution grid 120 with the customer 123 at which the EV 125 is charged, and the telematics derived information from OEM 603 on the EV 125, a load manager 605 can determine an optimized charging control to coordinate the charging of EV 125 and other EVs that charge through the distribution transformer 121. The charging control data can schedule the charging of the EVs as illustrated in FIG. 4 or 5, in a manner the takes into account both the properties of the local distribution network 120 and the usage pattens of the individual EVs, such as 125, that use the local distribution network 120. The discussion here focuses on the distribution transformer, but some embodiments can also incorporate information on upstream elements of the local distribution network 120 such as power ratings or other data on substation 107 and feeders in the distribution network. The charging control can then be transmitted to the on-board control systems, such as 615, that then charge the EVs according to the schedule. This information can be provided to the EV by, for example, a Wi-Fi connection or via its on-board (3G or 4G) antenna. Depending on the embodiment, the charging schedule can be sent by way of the EV's OEM 603 or directly from the load manager 605, such as by an internet connection to the customer's Wi-Fi. Similarly, the telematics can alternately or additionally be provided to the load management system without going by way of the EV's OEM 603 in some embodiments. In this way, the EV receives its charging schedule, independently of any charging apparatus, such as a charging station, that the customer would be using at the home to supply the EV. Charging schedules and other information from the load manager 605 can also be provided to the utility 601 for use in managing of the power grid 100 and to EV OEMs for use in EV development.

In addition to determining scheduling for the EVs, the embodiments presented here for the load manager 605 can also provide advanced capabilities for electric utilities 601 to both better understand electric vehicle charging behavior and implement reliable and cost-effective residential load management programs. The load manager 605 can connect directly to vehicle telematics units by integrating with EV OEM 603 existing cloud data infrastructure to both collect data and send charging control information back to the vehicle. This direct approach can provide utilities 601 a high level of data accuracy, providing EV users with a charging schedule that minimizes interference with drivers' use of their EVs, whilst ensuring that the utility's 601 distribution network 120 is not overloaded.

Embodiments presented here can avoid the need for customers to install and set up external hardware equipment, such as Wi-Fi-enabled electric vehicle supply equipment (EVSE) or vehicle on-board diagnostic (OBD) devices. The approach described with respect to FIG. 6 can be a cloud-based setup that reduces program complexity, improves the customer experience, and increases compliance rates for participants while avoiding the need for costly individual service actions. It also allows customers flexibility, as it is brand and device agnostic, equally permitting use of hard-wired EVSE, NEMA (National Electrical Manufacturers Association) plug-based EVSE, or manufacturer-included mobile connector for home charging.

The approach illustrated with respect to FIG. 6 can also generate clearer insights into EV usage. Off-board connected EVSE for residential use generally do not have the ability to observe vehicle state of charge, which is important both for understanding driver charging behavior and for balancing driver and utility objectives under any load management protocol.

The access of the load manager 605 to direct measurement information from an EV's on-board control systems 615 also provides greater individualized granularity and precision than disaggregation-based approaches. Disaggregation relies only on whole-home level load data from AMI as measured by the smart meter 611-a. In the approach presented here, the charging load is directly measured through the onboard vehicle controls rather than approximated from changes in the bulk data. Since this method is vehicle-based, rather than location-based, collected data provides the utility 601 with more accurate information on both home and public charging behavior and EV needs. The on-board diagnostics of the EV's on-board control systems 615 can fill in the gaps on battery and location data that would otherwise be difficult to compile and would require the introduction of addition hardware on a customer's charging apparatus.

During customer onboarding, the load manager 605 can receive permission to access vehicle data through the EV's OEM 603 as connected to vehicle platform 125. Information on vehicle type, make, model and year is supplied from the vehicle's EV telematics or through information embedded in the Vehicle Identification Number (VIN). This data is linked to the utility service account and service point, with geofencing used to verify charging location. Service point interval meter data from the utility 601 may be used in some embodiments, when available, for measurement and verification purposes. Information on distribution system network structure and asset inventory from the utility 601 can be shared with the load manager 605 to improve on default demand response and support distribution system awareness and integrated local charging schedule optimization.

Considering the data from the EV, vehicle telematics data can be collected directly from the EV's onboard telematics system of the on-board control systems 615. The load manager 605 can access to this data through an application programming interface (API), requiring username and password authentication by the vehicle owner. While APIs can vary by manufacturer and model, these generally provide sufficient data for optimizing charging schedules. This data can be collected via real- or near real-time pull requests for specific information at regular intervals, sent to the vehicle telematics unit, or alternately through bulk data downloads, depending on the embodiment. Decisions around frequency and method depend on both specific vehicle model capabilities and program requirements.

Among the data fields that can be provided by the EV's onboard telematics system of the on-board control systems 615 can include:
Vehicle location (latitude/longitude);
Battery state of charge;
Plug-in status;
Charging status; and
Odometer.

Additional endpoints (e.g. grid voltage and charging current) may be available depending on vehicle model capabilities, which contribute further detail.

These received data can be used to generate and infer additional event information, including EV charging events, that can include:
Location of charge event (latitude and longitude);
Date and time of charge event start/end;
Battery state of charge start/end; and
Number of kWh consumed in each charge event.

It should be noted that the load manager 605 is not interested in tracking individual trips or maintaining records of participant location, except where needed to support program objectives or assess compliance. As location data contains sensitive personal information, the load manager can place appropriate internal restrictions on access to individual location data and ensure all use of location data is narrowly focused on satisfying the residential charging program objectives.

During the load management phase of EVs' load management, the load manager 605 can send charging commands directly to a vehicle. These commands vary, depending on system capabilities and embodiment, but can include:
Scheduled vehicle charging, using set times when the vehicle is allowed to charge while plugged in, thus preventing charging during the times outside of the charging schedule, even if the vehicle is plugged in;
Setting a “charge-by” time, which sets the vehicle's charging start time such that the EV battery reaches full charge by the charge-by time;
Real-time signals to start and stop charging, sending push requests to vehicles which initiate or halt active charging; and
Real-time signals to modify charging rate, sending push requests to alter the charging amperage in order to dynamically control charging power at intermediate levels.

These capabilities can be used by load manager 605 to manage charging under specified demand response events, and subsequently for daily charge scheduling in coordination with utility load management objectives and distribution system constraints.

Considering now the data provided from the utility 601 to the load manager 605, various categories of information possessed by utility 601 can be shared with load manager 605. This data can be grouped into four categories:
Service account data;
Demand response events;
Smart meter data (AMI); and
Distribution system information.

Service account information can be used to link a customer's EV and utility accounts together, determine valid home charging locations, and conduct measurement and verification. The utility 601 can convey demand response events to load manager 605. Smart meter data can be used for verifying EV load measurements and reductions through an independent monitoring channel, and to enable more comprehensive analysis and additional system context. Distribution network information, including relational and asset data, can be used to support advanced system awareness tools and associated load management strategies.

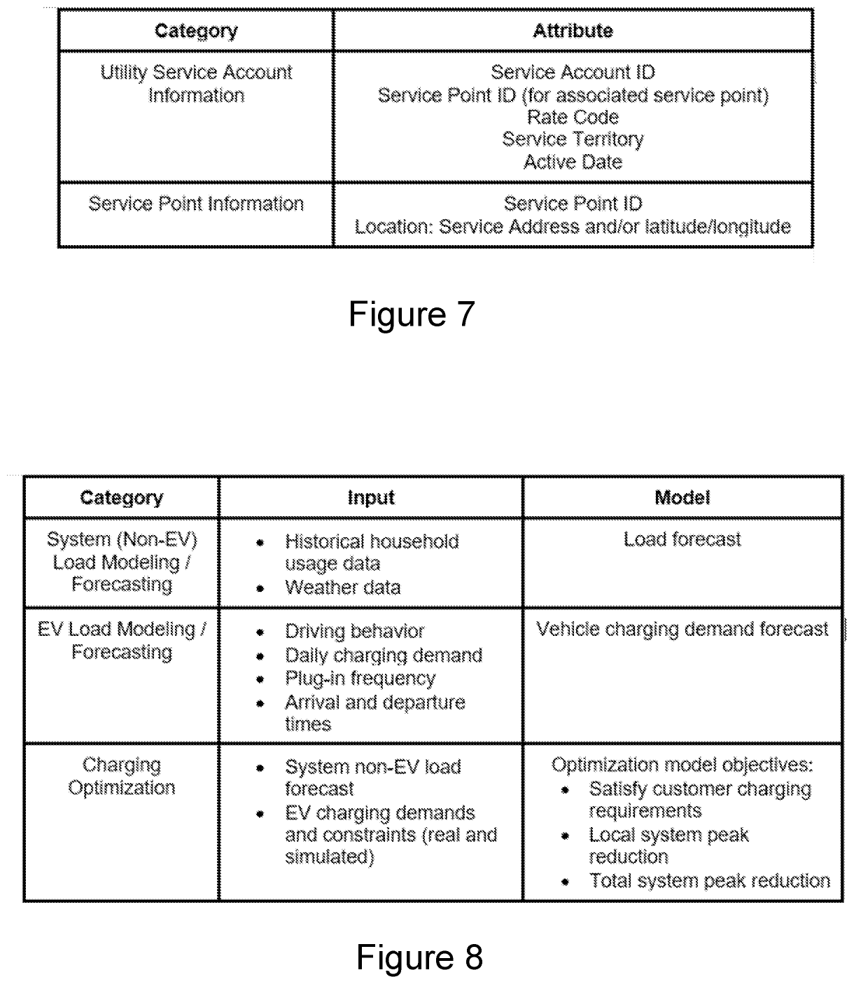

FIG. 7 is a table illustrating examples of service account data that can be provided from a utility 601 to the load manager 605. Service account and service point information can be used to verify customer eligibility and program compliance, and to connect vehicle and utility accounts. The utility service account information can include: service account ID; service point ID (for associated service point); rate code; service territory; and active date. The service point information can include a service point ID and location information, such as a service address, latitude/longitude, or both. The location information can be used to link reported charging activity (from car data) with the registered location of charging, ensuring that charging occurs at a home location according to the program, and thus ensuring program compliance.

In some embodiments, the load manager 605 can implement the capability to respond to demand response (DR) events generated by the utility 601 that indicate periods during which EV charging cannot occur, by communicating directly with vehicles to carry out utility requirements. DR events can be received from a utility 601 in formats that can include simple email notification or more elaborate protocols such as an Open Automated Demand Response (OpenADR), depending on the embodiment. In the OpenADR case, the load manager 605 could deploy a custom Virtual End Node (VEN) as part of its production deployment for purposes of responding to events.

With respect to smart meter data, smart meter data (AMI) on energy usage interval data can be provided periodically and include service point usage data, such as: Service Point ID; Read Date; Read Time; and Usage Value (kWh). For customers, AMI data can be used to verify compliance by correlating power consumption at the customers' home service point with charging activity reported by the EV. Use of territory-wide AMI data can be used to determine the aggregate transformer load. Since the load manager 605 has access to reported charging behavior from EV data, non-flexible baseline load can be estimated by netting out reported EV charge load. This baseline load can be a useful input into the load management strategy.

The load manager can integrate information on low-voltage distribution system topology/architecture and assets, including meter-to-transformer mappings. Examples of such data can include transformer specifications, such as: transformer ID; transformer location (e.g., Latitude/Longitude); transformer rating (kVA); and install date (if available). Additional transformer model specifications (if available) can include: top oil rise; thermal capacity; meter-to-transformer links; meter ID; transformer ID; and active date (when meter-to-transformer link was established). This information provides system context for understanding EV charging impacts, allowing identification of current and future at-risk assets through predictive analysis. This information can be provided from the load manager 605 back to the utility 601 as an aid in investment planning decisions and to support more advanced load management strategies.

The load manager 605 can provide advanced EV load management through its integration with AMI data from smart meters 611 and data on the low-voltage distribution system 120 from the utility 601. This integration can allow the load manager 605 to provide the utility 601 with better understand charging behavior within residential load contexts, identify potential system hotspots, and refine future distribution planning and maintenance. In addition to informational benefits, the load manager 605 can use this information to support a more advanced load management strategy, running automated daily charging optimization to solve for both local and system peaks, as well as other important system criteria that the utility 601 may favor, such as emissions intensity of the energy used for charging, etc.

The techniques presented here can be applied more broadly to other loads on a local distribution system, but can be particularly relevant for EV load management as the rapid, clustered adoption of EVs may cause reliability challenges given the lack of real-time monitoring on the low-voltage parts of the grid, which often suffer from lack of data.

FIG. 8 is a table to illustrate components that can be used in embodiments of algorithms for the load manager's control software to schedule charging to minimize stress on constrained system components such as transformers, while enabling overall higher asset utilization. The first column of FIG. 8 lists categories of inputs, the second column gives some examples of these inputs, and the third column gives corresponding models.

A first category for the algorithm inputs is the non-EV system load modeling and forecasting for power grid 100, reflecting the demands on the grid other than the EV charging. Referring back to FIGS. 3-5, this corresponds to the usage throughout the day without the added on EV charging bars. The inputs for modeling and forecasting non-EV usage can include historical household usage, as can be provided by the utility 601, and weather data. These inputs can be used for modeling a load forecast.

The EV portion of load modeling and forecasting can be provided by the telematics data from the EVs' on-board control systems. Examples of this data can include, for each EV, the daily driving behavior, daily charging demand, plug-in frequency, and arrival and departure times. This data allows the load manager to forecast the charging demand for each EV, such as the amount of charging that the EV will likely require and when this can be done.

From the non-EV load forecast for the system combined with the EV charging demands and constraints, both read and simulated, the load manager 605 can perform charging optimization. As discussed in more detail below, the optimization model's objectives can include meeting the customer's charging requirements, peak reduction on the local distribution network 120, and also peak reduction on the larger systems of the power grid 100.

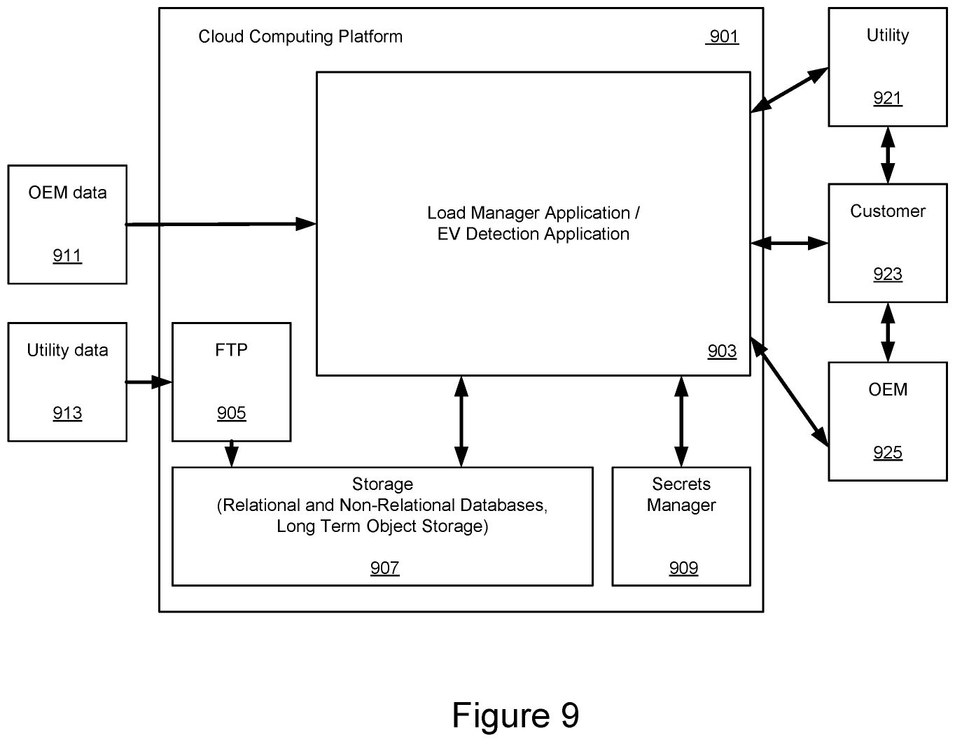

FIG. 9 is a schematic representation of an embodiment for the technology platform for implementation of the load manager. In the embodiment of FIG. 9, the load manager is implemented in the cloud in a cloud computing platform 901, such as Amazon Web Services (AWS) or similar service. In other embodiments, some or all of the components described with respect to FIG. 9 can be implemented on servers or other computing devices operated by the load manager. Embodiments for the load manager platform can be EV manufacturer agnostic, enabling utilities to aggregate EV charging data and control across their entire distribution network. The platform is designed to collect data directly from the EVs and reconcile that information with the service account meter to determine a vehicle's load effect on an electrical distribution grid.

The cloud computing platform 901 in the embodiment of FIG. 9 includes the load manager application 903 along with memory for use of the load manager. (The EV detection application will be discussed below.) The memory includes both a general memory storage 907, such as for a relational and non-relational databases and long term object storage, and also a “secrets manager” 909 for more confidential data (e.g., EV location data or user account data that contains sensitive personal information). Data from EV manufacturers, OEM data 911, on the EVs can be received by the load manager application 903 and utility data 913 can be stored, via file transfer protocol (FTP) block 905 to the storage 907. The customer (i.e., EV owner) 923 can exchange data with both the utility 921 and the EV OEM 925, with each of Utility 921, Customer 923, and OEM 925 in communication with the load application manager 903.

The customer, or user, 923 can authenticate with both the utility 921 and the manufacturer (OEM) 925 of their EV using, for example, an open standard authorization framework for token-based authorization on the internet, such as OAuth2. All access tokens from these authentication events can be stored securely in a secrets' manager 909. On a schedule (e.g., every 15 minutes) the load manager application 903 can download detailed EV data and store it in a non-relational database of storage 907 for easy retrieval. On an independent schedule, the utility can upload utility data 913, which can simultaneously be loaded into databases for analytics purposes and archived in long-term storage of storage 907. An analytics engine can use data from the OEM database 911 and utility database 913 and stores results in the storage 907, with older data eventually being archived into long-term object storage. A web portal and mobile application for the customer 923 can provide a user experience for viewing charging/energy consumption data and interacting with the managed charging process. Microservices can be deployed within the load manager application 903 for data reconciliation, charging optimization, and charge control through EV APIs.

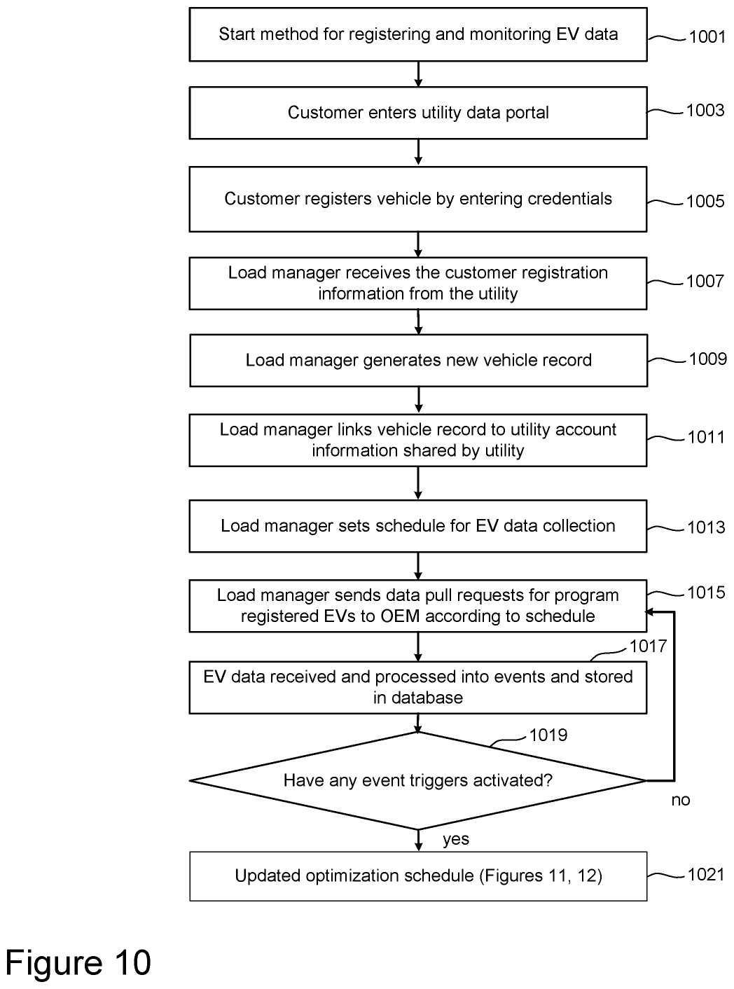

FIG. 10 is a flowchart of an embodiment for the registration and monitoring of EV data, starting at 1001. At step 1003, a customer enters a utility data portal, such as by logging in to the utility's website. The customers can be the owners of individual cars or other EVs, or could be the owner or operator of a fleet of EVs. The process can be performed by a customer that already has an EV that is charged at a given address, when a customer moves to a new address, or when the EV is initially acquired, such as at a dealership at time of purchase. The data portal can be specific to the customer's local utility or common to multiple utilities. When a customer moves, or changes charging location, the customer may need to register with a different utility or, in some embodiments, the customer's data can migrate to a new utility by updating of charging address. Once at the utility data portal, the registration of the EV or EVs by the customer is performed at step 1005 by entering of the vehicle credentials. For example, these credential can be provided by an EV's OEM mobile application.

At step 1007 the load manager receives the customer registration information entered at step 1005 from the utility. From this information, the load manager generates a new (or updated) record for the EV at step 1009 and, at step 1011, links the record to utility account information shared by the utility. The load manager can then set a schedule for data collection for the EV in order to set and update charging schedules at step 1013. Based on the information from steps 1003-1013, the EV can then be entered into the load managers scheduling process along with other registered EVs.

At step 1015 the load manager sends data pull requests for the registered EVs. This request can be sent to the OEMs of the registered EVs, although in some embodiments this information could alternately or additionally be provided to the load manager directly from some or all of the registered EVs. For example, in a cloud based implementation, the load manager's cloud software sends the data pull requests for all program-registered EVs to the corresponding OEMs cloud service provider according to a schedule. In step 1017, the EV data is received by the load manager, processed into events, and stored in a database.

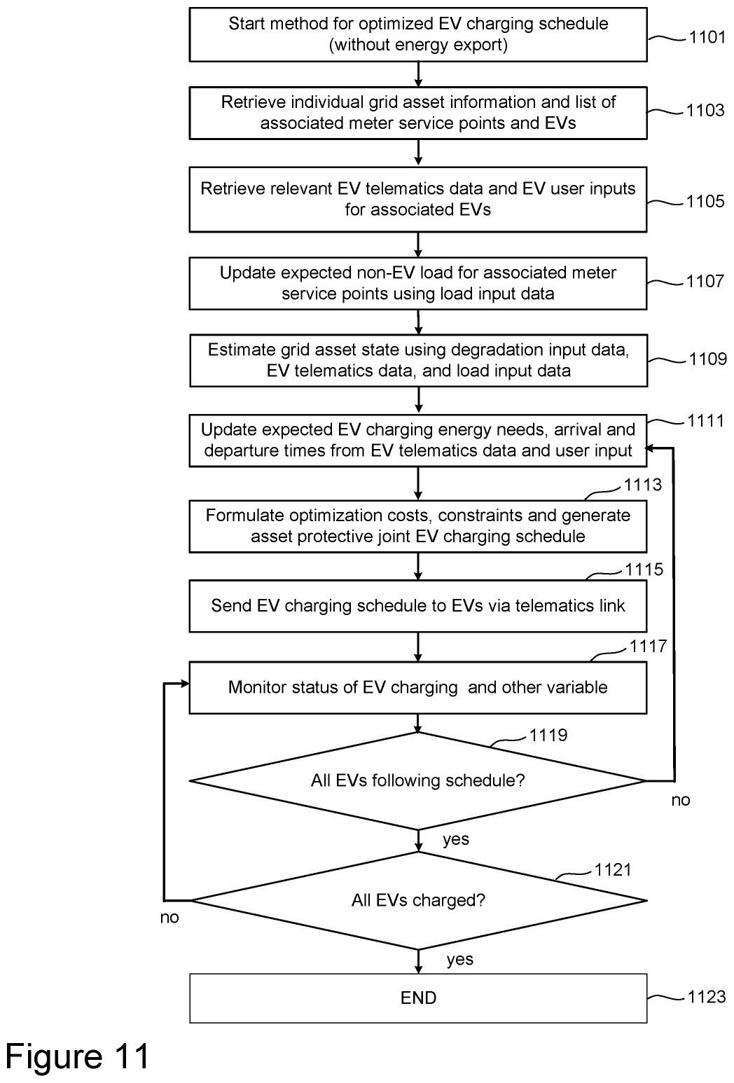

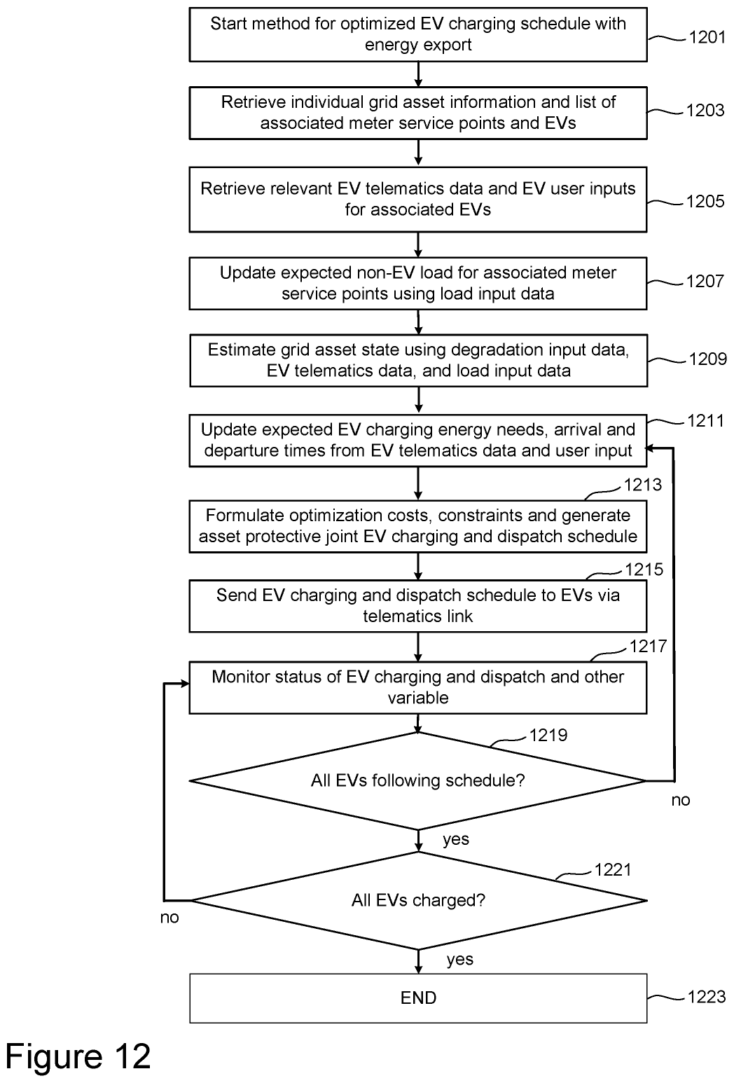

From the data processed into events in step 1017, step 1019 determines whether any event triggers have activated. Event triggers are events that require action by the load managing system. Examples of triggering events can include: an EV starts charging; an EV's GPS data indicates that it has entered a pre-set GPS zone, such an area around the EV's home charging location; or an EV's state deviates too far from expectations (e.g., battery charge state higher or lower than estimated), among other triggers. If there are no event triggers activated at 1019, the flow loops back to 1015 to continue monitoring. If there are any event triggers activated, at step 1021 the load manager can update the optimization schedule at step 1021 before returning to monitoring. Examples of actions at step 1021 can include updating the grid system state and updating the charging optimization schedule. The updating of step 1021 is considered in more detail with respect to FIGS. 11 and 12.

FIG. 11 is a flowchart for one embodiment of a method for optimizing EV charging schedules without energy export (i.e., without sending of power from a vehicle battery to the grid), starting at step 1101. At step 1103, the load manager 605 retrieves the grid asset information for the low voltage distribution networks 120, list of associated service points, and EVs. Grid asset information can refer to equipment of the low voltage distribution networks 120, such as information on step-down distribution transformers 121 like limits or costs related to throughput. This information can have previously been provided from the utility 601 to the load manager and be in storage 907 on the load manager's cloud computing platform 901, for example, or supplied or updated at this time.

At step 1105, the load manager 605 retrieves relevant EV telematics data and EV use inputs for the associated EVs. The EV telematics data are information that can be transmitted from onboard computers of the on-board control systems 615 of an EV 125 to a cloud computing service, for example, either directly to load manager 605 or by way of OEM 603. The EV telematics data can include information such as location, charging status, battery state of charge, voltage, current, power, as well as historical data or composite data, such as energy added over a charging session. This information can have previously been provided from the utility 601 to the load manager and be in storage 907 on the load manager's cloud computing platform 901, for example, or supplied or updated at this time from the EVs 125, OEM 603, or a combination of these. The EV user inputs are preferences provided by the owner of the EV, such as minimum charge levels or departure time. Depending on the embodiment, this information could be variously entered by the user by way of an app for this purpose, through the EV by way of the on-board control systems 615, or at the utility data portal (see step 1003 above).

At step 1107, the load manager 605 updates the non-EV load for associated meter service points using load input data. The load input data can use information such as account information for associated meter service points, utility meter data, and weather forecast data. Utility metering data refers to estimated or historical observed average power load or energy consumed for each meter service point. This information is frequently collected at regular intervals (e.g., hourly, 15 minutes, 5 minutes) and subsequently sends this information to the load manager in batches, such as by way of cloud computing services. The load manager then estimates grid asset state using degradation input data, the EV telematics data and non-EV load input data at step 1109, where degradation input data can include grid asset information, historical observed or estimated power loadings, and local weather data.

At step 1111, the load manager 605 updates the expected EV charging energy needs, arrival and departure times from the EV telematics data and EV user inputs, followed by formulating optimization cost and constraints, and generates an asset-protective joint EV charging schedule. In step 1113 the load manager formulates optimization costs and constraints, and generates asset-protective joint EV charging schedules. The optimization parameters and constraints depend on the embodiment and can include: cost, power rating of the asset, clean energy level percentages, customer battery levels needs, starting battery levels, power of charging, among other parameters. The weighting and integration of these parameters sets the constraints and cost function.

The load manager 605 sends out the EV charging schedules to the EVs 125 via telematics link with the EV's on-board control systems 615 at step 1115. The telematics link transmits the asset protective EV charging schedule that is the output of the optimization of step 1113. The optimization can include start/stop times for charging each of the associated EVs as chosen by an optimization algorithm includes grid asset information and vehicle telematics data, and can further include information such as price signals, emissions factors, and EV user inputs.

After sending out the schedules, next follows charging each of the EVs, based on the corresponding charging schedule. At step 1117 the load manager 605 monitors the status of EV charging, along with variables such as conditions on the local distribution networks 120. Step 1119 determines whether the EVs are actually following charging schedules and, if not, the flow loops back to step 1109 to recompute the schedule to account for the discrepancies. If all of the EVs are following their corresponding schedules at step 1119, the flow continues on to step 1121 to determine whether all of the EVs have been charged and, if not, the flow loops to step 1117 to continue monitoring. If all EVs are found to be charged at step 1121, the flow ends at 1123.

FIG. 12 is a is a flowchart for one embodiment of a method for optimizing EV charging schedules when energy export is included. In this context energy export refers to the sending of power from a vehicle battery to the grid (or V2G), so that energy flows can be in both directions, from the grid to the EV, as in FIG. 11, and also from the EV to the grid. The flow of FIG. 12 includes the timing and optimization of this two-way flow. The flow of an energy from an EV to the grid is also referred to as “dispatch”. As before, there is the need to protect grid assets, such as transformer and feeders, but the incorporation of energy export adds flexibility (as power levels can go negative) and complexity (due to added costs and scheduling limits).

The flow of FIG. 12 starts at step 1201 and proceeds similarly to the flow of FIG. 11. At step 1203, the load manager 605 retrieves the grid asset information for the low voltage distribution networks 120, list of associated service points, and EVs. At step 1205, the load manager 605 retrieves relevant EV telematics data and EV use inputs for the associated EVs at step 1205. Relative to step 1105 of FIG. 11, in step 1205 the EV user inputs can now also include vehicle to grid participation variables. Steps 1205, 1207, 1209, and 1211 can correspond to steps 1105, 1107, 1109, and 1111 of FIG. 11.

At step 1213, the load manager 605 the load manager formulates optimization costs and constraints, and generates asset-protective joint EV charging schedules, when power flows from the grid to EV, similarly to step 1113, but now also generates dispatch schedules for when power flows from an EV to the grid. At step 1215 the load manager 605 sends out the EV charging schedules and dispatch schedules to the EVs 125 via telematics link with the EV's on-board control systems 615. The telematics link transmits the asset protective EV charging and dispatch schedule that is the output of the optimization of step 1113. The optimization can include start/stop times for charging or dispatch of each of the associated EVs as chosen by an optimization algorithm includes grid asset information and vehicle telematics data, and can further include information such as price signals, emissions factors, estimated dispatch costs (e.g., cost of marginal battery degradation) and EV user inputs.

After sending out the schedules, next follows charging each of the EVs, based on the corresponding charging schedule. The flow then continues to steps 1217, 1219, 1221 and 1223, which can be as described above with respect to steps 1117, 1119, 1121, and 1123 of FIG. 11, except now the monitoring of step 1217 is for the two-way flow between the grid and the EV, including EV dispatch as well as charging.

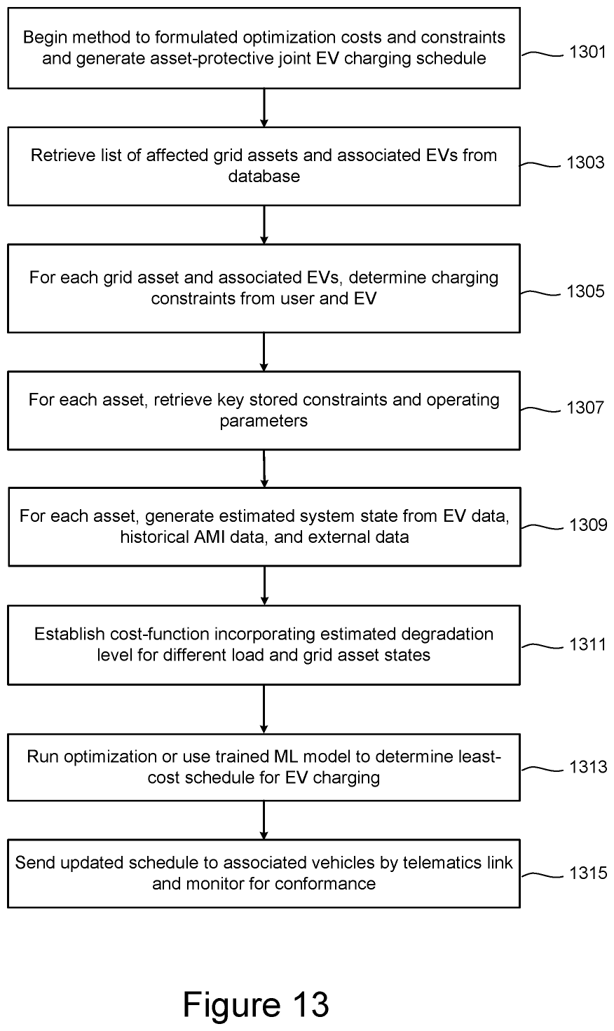

FIG. 13 illustrates an embodiment of a flowchart for a schedule optimization flow to generate asset-productive joint EV charging schedules. The flow for a method to formulate optimization costs and constraints and generate joint EV charging schedules that can protect the assets of the distribution grid begins at 1301. At step 1303, the load manager 605 retrieves the list of affected grid assets and associated EVs from its database, such as storage 907. The load manager can also receive additional or updated grid asset information from the utility 601 and additional or updated EV information from OEM 603 or directly from EVs 125. For each grid asset, such as the low-voltage distribution transformers 121 or other parts of the local distribution network 120, and its associated EVs 125, the load manager application 903 determines charging constraints from user and EV data at step 1305.

At step 1307, the load manager 605 retrieves the key stored constraints and operating parameters from its database, such as storage 907, where the load manager can also receive additional or updated grid asset information from the utility 601. For each asset, the load manager application 903 can then generate estimated system state from vehicle data, historical AMI data, and external data (such as temperature or projected temperature) at step 1309.

In step 1311, the load manager application 903 establishes a cost function. The cost function can incorporate estimated levels of degradation for the local distribution grid 120 for different load levels and also local grid asset states for things such as estimated internal temperatures for assets, such as in a distribution transformers 121 under these load levels. The optimization for the cost function is ran at step 1313. This can be a convex or integer optimization, for example, or use a trained machine learning model. The optimization determines the least cost (in terms of the cost function) schedule for charging the associated EVs. At step 1315 the load manager 605 sends updated schedules to all of the associated vehicles. For example, this can be done by way of the corresponding OEMs 603 by way of a cloud telematics link to the on-board control systems 615 of the associated EVs and can include monitoring for conformance. In alternate embodiments, the updated schedule can be sent to the on-board control systems 615 of one or more of the associated EVs without going through the OEM 603.

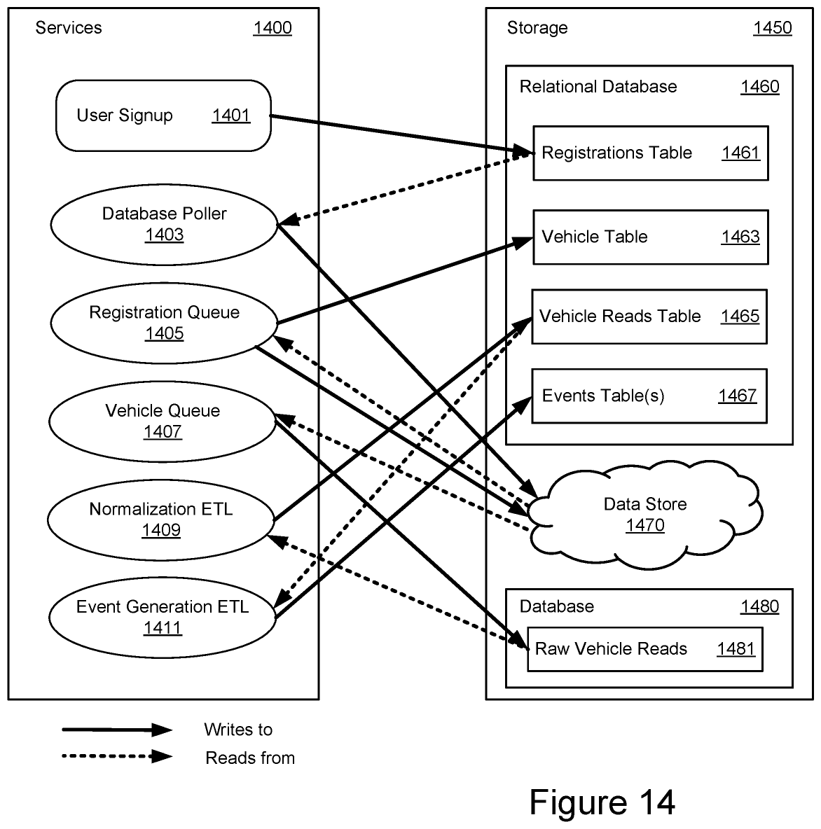

FIG. 14 is a schematic representation an embodiment for the vehicle dataflow between some of the services 1400 in the flows of FIGS. 10-13 and storage 1450 used by the load manager's computing platform 901. Referring back to FIG. 9, the storage 1450 of FIG. 14 can corresponding to the storage 907 and can also include secrets manager 909 in some embodiments. Services 1400 can form part of the load manager application 903.

Storage 1450 is shown segmented into a relational database 1460, database 1480, and data store 1470 for more general data storage. The database 1480 can be used to store the raw vehicle data 1481 for the EVs as it is received by the load manager platform. The relational database 1460 can include relational databases such as an EV registration table 1461, a vehicle table 1463, a vehicle reads table 1465, and events table(s) 1467. Included within the services are user signup 1401, database poller 1403, registration queue 1405, vehicle queue 1407, normalization ETL (Extract, Transform, Load), and event generation ETL 1411. Examples of writes to storage elements from services are represented by solid arrows and reads from storage to services are represented broken lines.

On the services side, one embodiment of the user signup 1401 can be as described with respect to steps 1003 and 1005 of FIG. 10, where a customer registers an EV by way of a utility portal. The registration information can then be used generate records for the EVs, which can then be written into the registrations table 1461 as part of a relational database for such records, as at steps 1009 and 1011 of FIG. 10. From the registrations table 1461, the database poller 1403 can read out data from the registration table 1461 as requested by load manager application 903. The database poller 1403 can then write the accessed data from the relational database 1460 into the general data storage 1470, from where it can be read by the registration queue 1405 and the vehicle queue 1407.

The registration queue 1405 is a function in the load manager application 903 that can create queues between the various databases so that customer registration data are not lost are they are read and written between various databases. Data from the registration queue can be used to write back to the vehicle table 1463 in the relational database 1460 and can also write data back into the general data store 1470. Similarly, the vehicle queue 1407 is a function in the load manager application 903 that can create queues between the various databases so that EV charging data are not lost are they are read and written between various databases, such as when writing the EV charging data into the raw vehicle reads 1481 of database 1480.

The particulars of the data, and how these data are presented can vary depending on the EV. For example, different OEMs may provide different information and, even when the information is the same, it may be in a different formats. Even for same OEM, the information may vary between different vehicles as, for example, an electric truck might have different relevant data that are monitored than an electric car. To account for this, the normalization ETL 1409 can read out the raw vehicle reads 1481 from database 1480, normalize the data values between the various EV types, and the write the normalized data into the vehicle reads table 1465, as in step 1017 of FIG. 10.

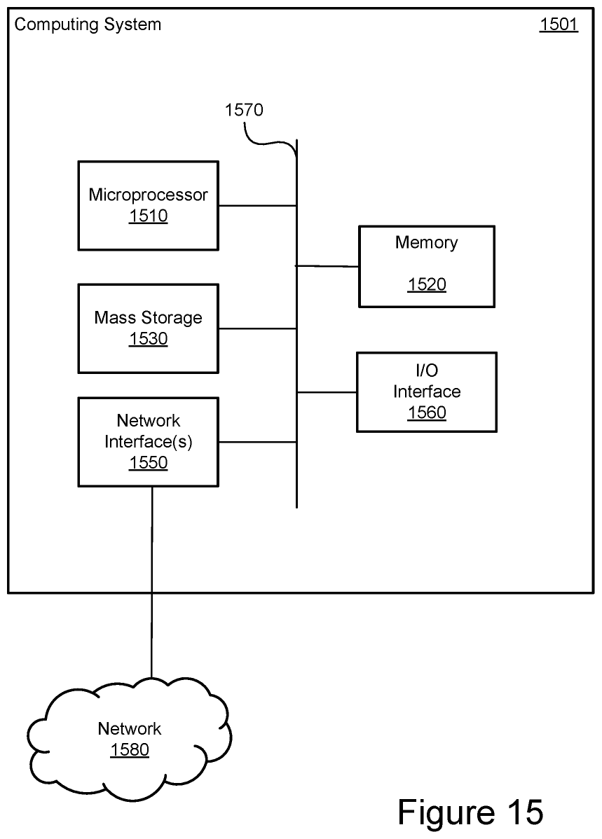

FIG. 15 is a high-level block diagram of a computing system 1501 that can be used to implement various embodiments of the load managing techniques described above. In one example, computing system 1501 is a network system. Specific devices may utilize all of the components shown, or only a subset of the components, and levels of integration may vary from device to device. Furthermore, a device may contain multiple instances of a component, such as multiple processing units, processors, memories, interfaces, etc. In one set of embodiments, the computing system 1501 can be implemented as a part of a cloud computing platform. Relative to FIGS. 9 and 14 above, the storage 907/1450 and secrets manager 909 can be part of memory 1520, mass storage 1530, or a combination of both; FTP block 905 can be included within the network interfaces 1550; and the load manager application 903, including the services 1400, can be performed within the central processing unit or units 1510.

The network system may comprise a computing system 1501 equipped with one or more input/output devices, such as network interfaces, storage interfaces, and the like. The computing system 1501 may include a central processing unit or units (CPU) 1510, a memory 1520, a mass storage device 1530, and an I/O interface 1560 connected to a bus 1570. The computing system 1501 is configured to connect to various input and output devices (keyboards, displays, etc.) through the I/O interface 1560. The bus 1570 may be one or more of any type of several bus architectures including a memory bus or memory controller, a peripheral bus or the like.

The CPU 1510 may comprise any type of electronic data processor. The CPU 1510 may be configured to implement any of the schemes described herein with respect to the pipelined operation of FIGS. 2-6, using any one or combination of steps described in the embodiments. The memory 1520 may comprise any type of system memory such as static random access memory (SRAM), dynamic random access memory (DRAM), synchronous DRAM (SDRAM), read-only memory (ROM), a combination thereof, or the like. In an embodiment, the memory 1520 may include ROM for use at boot-up, and DRAM for program and data storage for use while executing programs.

The mass storage device 1530 may comprise any type of storage device configured to store data, programs, and other information and to make the data, programs, and other information accessible via the bus 1570. The mass storage device 1530 may comprise, for example, one or more of a solid-state drive, hard disk drive, a magnetic disk drive, an optical disk drive, or the like.

The computing system 1501 also includes one or more network interfaces 1550, which may comprise wired links, such as an Ethernet cable or the like, and/or wireless links to access nodes or one or more networks 1580. The network interface 1550 allows the computing system 1501 to communicate with remote units via the network 1580. For example, the network interface 1550 may provide wireless communication via one or more transmitters/transmit antennas and one or more receivers/receive antennas. In an embodiment, the computing system 1501 is coupled to a local-area network or a wide-area network for data processing and communications with remote devices, such as other processing units, the Internet, remote storage facilities, or the like. In one embodiment, the network interface 1550 may be used to receive and/or transmit interest packets and/or data packets in an ICN. In particular, the network interface 1550 can include the one or more interfaces by which the load manager application 903 can receive and transmit the various data and information described above, including charging schedules, EV telematics, and local distribution networks. Herein, the term “network interface” will be understood to include a port.

The components depicted in the computing system of FIG. 15 are those typically found in computing systems suitable for use with the technology described herein, and are intended to represent a broad category of such computer components that are well known in the art. Many different bus configurations, network platforms, and operating systems can be used.

The foregoing discussion included a process for customers to register their EVs, such as in the embodiment discussed above with respect to FIG. 10. However, not all users of EVs will be registered or otherwise accurately known to a utility or load manager applications. Having a better knowledge of the EVs being used in a region can be extremely useful not just to the load manager for accurate determination of scheduling, but also to utilities for the planning and management of infrastructure, for marketing purposes, and other uses. The following discussion presents techniques for such accurate EV detection.

Utilities may have a record of users (i.e., customers) that have one or more EVs, based on information from customers registering as described above, signing up for rate discounts or rebates, or other information, but such information may not be accurate, either through not being accurate to begin with or else not being current. In addition, such information could also miss EVs that have not been registered in some form with the utility or other entity, so that both the record of customers that do and that do not have EVs can be quite inaccurate. Electricity usage can be monitored for evidence of EV charging, but a determination based on such total electricity consumption can be of limited accuracy as it can be difficult to disentangle EV usage from other usages.

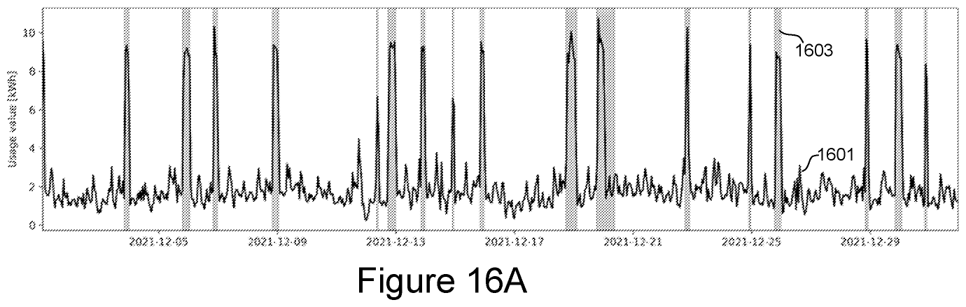

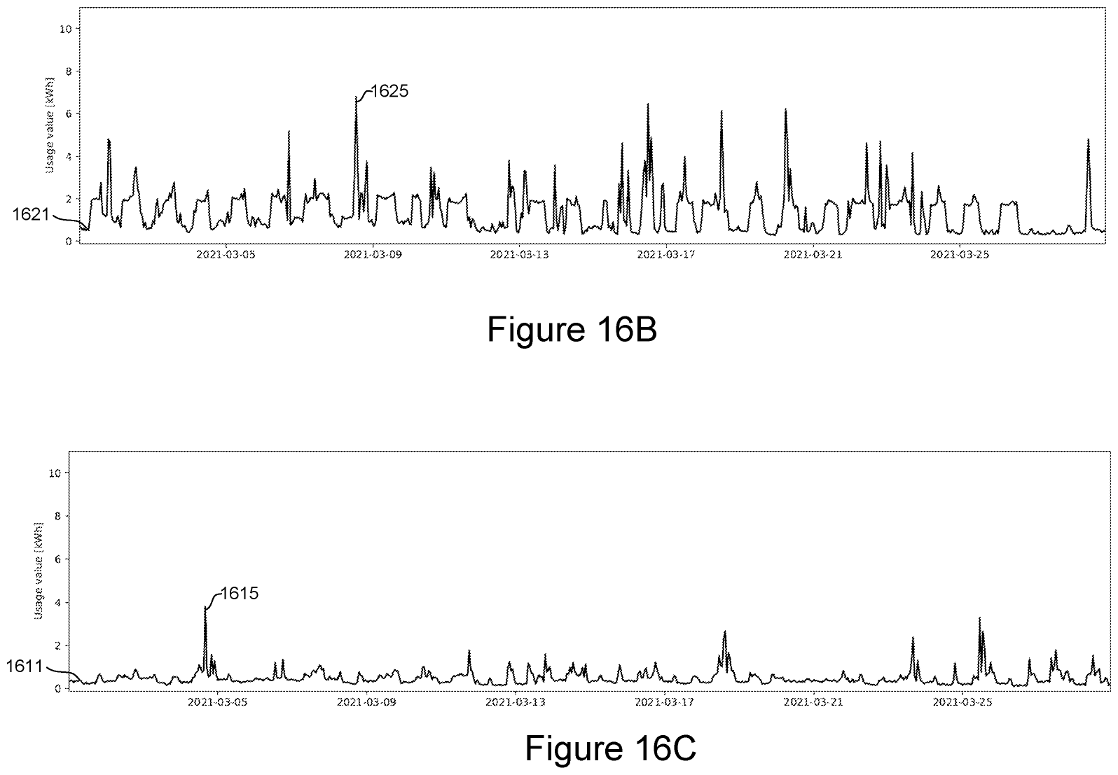

To more accurately detect household or other points at which EVs are being charged, the following presents techniques that combine usage data of electricity usage over an extended period of time of households or other locations, data on whether or not the locations are or are not associated with charging an EV or EVs, and telematics data from EVs to train a machine learning model. Once trained, the model can then be applied to electricity usage data (such as AMI data) to accurately detect EVs. The situation can be illustrated with respect to FIGS. 16A-16C.

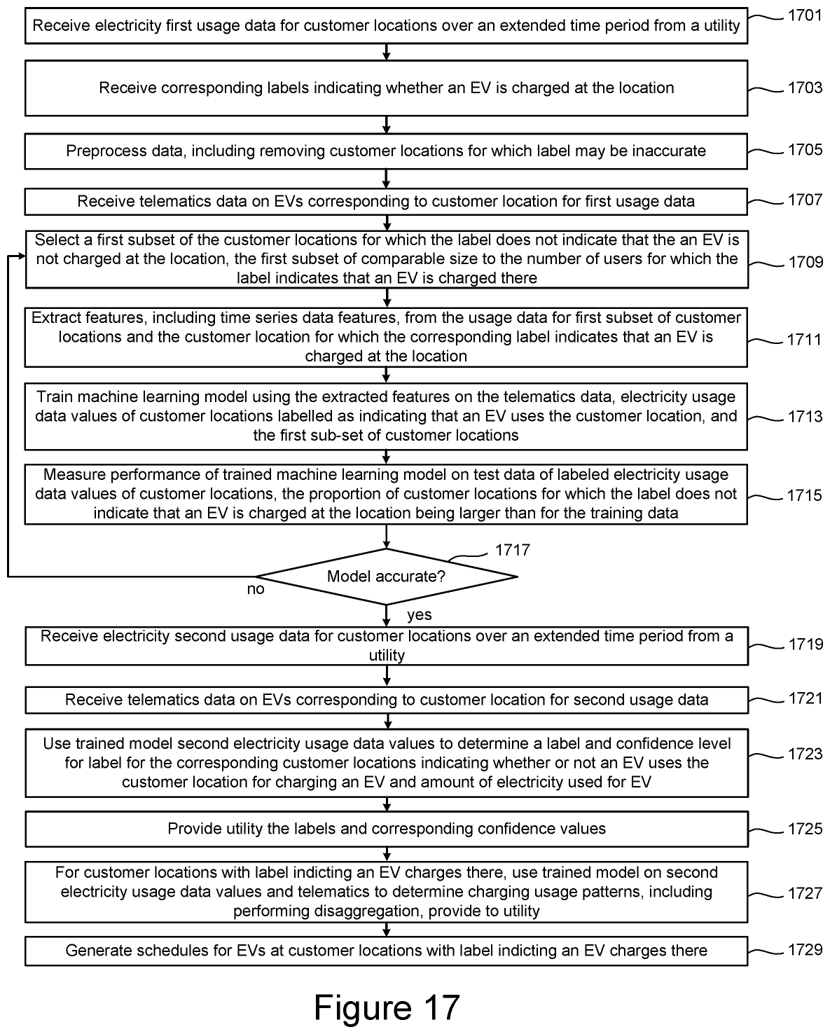

FIGS. 16A-16C provide several examples of a user location's (e.g., a household) electricity usage over a multi-week time interval, for both locations where an EV is charged and is not charged. In this example, the usage data is AMI data over a 28 day period, where the values are at atemporal resolution of one hour, although other values, such as 15 minute intervals, can be used. FIG. 16A illustrates an EV household's AMI electricity data usage 1601. The usage data 1601 is spikey, but where these fluctuations are over a fairly limited range, and also includes a number of larger spikes. In this example, these larger spikes correspond to charging events 1603 in the shaded regions, where, as discussed further below, this information can be from separately supplied telematics data. In FIG. 16A, the shaded spikes such as in region 1603 are charging events, but in other cases a user location that charges an EV may include additional spikes that are comparable to or larger than the spikes of the known charging events. FIGS. 16C and 16B respectively correspond to non-EV households with and without high usage spikes in their usage data. In some cases, the usage pattern of FIG. 16B may be an EV household, but one that has not been labeled as such. In FIG. 16C the fluctuations in the usage values 1611 are over a relatively small range, similar to the usage data 1601 of FIG. 16A without the shaded charging events, so that any spikes, such as at 1615, are of relatively small amplitude and short duration. FIG. 16B's usage data 1621 does exhibit usage spikes such as at 1625 of an amplitude similar to the spikes of known charging events of FIG. 16A. If all EV households' usage were similar to that of FIG. 16A, and all non-EV households' usage were similar to FIG. 16C, it would be relatively straightforward to determine with some degree of confidence whether or not a household was an EV household. However, usage patterns for an EV household with non-charging event spikes or for a non-EV household such as that of FIG. 16B make it difficult to accurately determine whether or not a user location is used for EV charging without relying upon telematics or other additional information that identifies charging. This can be even further complicated in situations where the charging patterns are irregular or multiple EVs use a single charging location. To be able to more accurately detect households (or, more generally, charging locations) for EVs, the following discussion presents techniques to more accurately detect EVs. FIG. 17 presents many of the features that can be incorporated into such a process.

FIG. 17 is a flowchart of an embodiment for EV detection, where the particular steps included and the details of each of these steps will vary based on the particular embodiment. In step 1701 a first set of electricity usage data that will be used as a labeled training population is received for multiple customer locations over an extended period. In the following, the user locations will often be referred to as households, but more generally could be a commercial user or a multi-unit dwelling, for example. Referring back to FIG. 9, in an example embodiment an EV detection application 903 can be performed in a cloud computing platform 901 embodiment. (The load manager application aspects can be an independent application on the same or a different cloud computing platform and is discussed above.) The first set of electricity usage data can be utility data 913, such as AMI data for the user locations and will measure the total combined usage data at that location, including any level 1 (L1, e.g. 120V) or level 2 (L2, e.g. 240V) charging usage at that location over an extended period of time, such as for multiple months or a year. By using data over an extended period, such as for multiple months or a year's worth, in addition to providing a large data set for training purposes, it can also capture factors such as seasonal variations in customer usage. With respect to the temporal resolution of energy usage data, this can be for 5 minute, 15 minute, 30 minute, or 1 hour intervals, for example, depending on the format of the AMI data.

At step 1703 a corresponding set of labels is received by the EV detection application 903 for members of the labeled training population of user locations. These training labels indicate whether a user location is used for EV charging and in the following training of a machine learning model to detect EVs from electricity usage data when such labels are not available. The members of the total population of user locations will fall into three categories: those with a YES label; those with a NO label; and unlabeled user locations. The YES and NO users are used for the training population. YES households (or, more generally, user locations) are those where there is some independent information about EV ownership or charging at that location. The YES labels may be part of the data 913 provided by the utility and come from sources such as customers signing up for discounts or rebates or from other sources when a household might provide such information, such as applying for a tax rebate or registering for charging schedules as described above, from EVSEs, or from telematics. In some embodiments a YES value can include the number of EVs at the customer location, or, in alternate embodiments, could include additional information such as whether L1 or L2 charging is used or the date at which EV charging began at this location. The number of YES labeled households is extremely small, typically much less than 1% of the total population of user locations, and so is a sparse data subset within the full population. This is due to the fact that the actual concentration of EVs in the total population is small (a few percentage, typically ˜1% in most US locations), and furthermore the number of known EVs in the total population is small.

NO user locations are labeled as non-EV user locations may also be a small subset of households randomly selected from the total population of user locations not in the YES sub-population. In current levels of usage, most of these households will not have an EV, because EV adoption is still small, but the process does not make such assumptions for the model. The size of the NO population can be somewhat arbitrary, although often a few times that of the YES population. The unlabeled user locations are the households of the total population of user locations not in either the YES or NO sub-populations. The process of FIG. 17 is for the purpose of generating a model to predict the presence or absence of EV charging for the user location in unlabeled category.

Preprocessing of the labeled training population follows at step 1705. Although the EV detection application 903 receives a corresponding label for some the households in the training population, some of these labels may be of low quality and these inaccurately labeled households are removed from the training population. For example, a household may have a YES label due to signing up for a rebate, but it may not actually be an EV charging location due to not actually having (or no longer having) an EV or having an EV, but charging it elsewhere, for example. In one embodiment for households labeled as having an EV or EVs (YES label), households that do not have any high usage values can be filtered out, since if an EV charges there it would be expected that at least some high usage values would be detected. (If the YES labels are generated from EVSE or other telematics data, rather than for a utility for example, the EV detection process could directly filter users that charge at low powers, since the telematics can provide independent measurements of charging power, if the training process focuses on L2 charging.) In one embodiment for filtering households labeled as a non-EV (NO label), households that do exhibit characteristics of EV charging (e.g., sufficiently large usage spikes) can be removed from the labeled training population as likely being inaccurate. Because non-EV labels are generated by randomly selecting households not known to have an EV, a small percentage of these selected households will in reality have an EV, and can be discarded. These are just some examples of filtering out households with corresponding low quality labels, but other measures can be used to incorporate more refined tests. Other preprocessing can also include to clean up the usage data, such as: dropping unphysical large usage values; dropping negative usage value data; dropping “estimated” usage (i.e., where utilities try to estimate missing data); or filling in small gaps in usage data, for example.

In step 1707, in some embodiments telematics data (such as from EVSEs, OEMs, or the EVs) on charging events over the extended period is received by the EV detection application 903 for the corresponding user locations in the training data. In some embodiments, the telematics data can be used to generate YES labels, it which case step 1707 would occur before step 1703. (It will be understood that the order of steps in FIG. 17 is just an example, but other embodiments may use different orders or perform some steps concurrently.) As described above for the schedule generation aspects, the telematics data can come from the EV itself, from the OEM, or from an EVSE. The telematics data may also be used to filter out low-power EV charging during preprocessing in step 1705, and also to set the date for when a house was charging an EV, which can be used in feature extraction in step 1711. In the example embodiment presented here, the telematics data is not used at this point any further for the EV detection model and the only time series data that is input into the EV detection model is the AMI data. In an alternate embodiment the telematics data could be used to determine the occurrence and duration of charging events in an EV user location.

As noted above with respect to step 1703, it will often be the case that the number of customer locations in the labeled training population with a YES label can be several times smaller than the number of user locations with a NO label. For training, it is often preferable to have the two sets of values to have a population of a similar size, so a sub-set of the NO labeled training population that is of similar size (e.g., roughly equal or within a factor of 2) is selected at step 1709, where this sub-set can be randomly selected. It is again noted that, although the process of FIG. 17 in not limited to this case, typically only a small subset of the entire population is explicitly labeled (i.e., YES or NO), with the remaining population unlabeled.

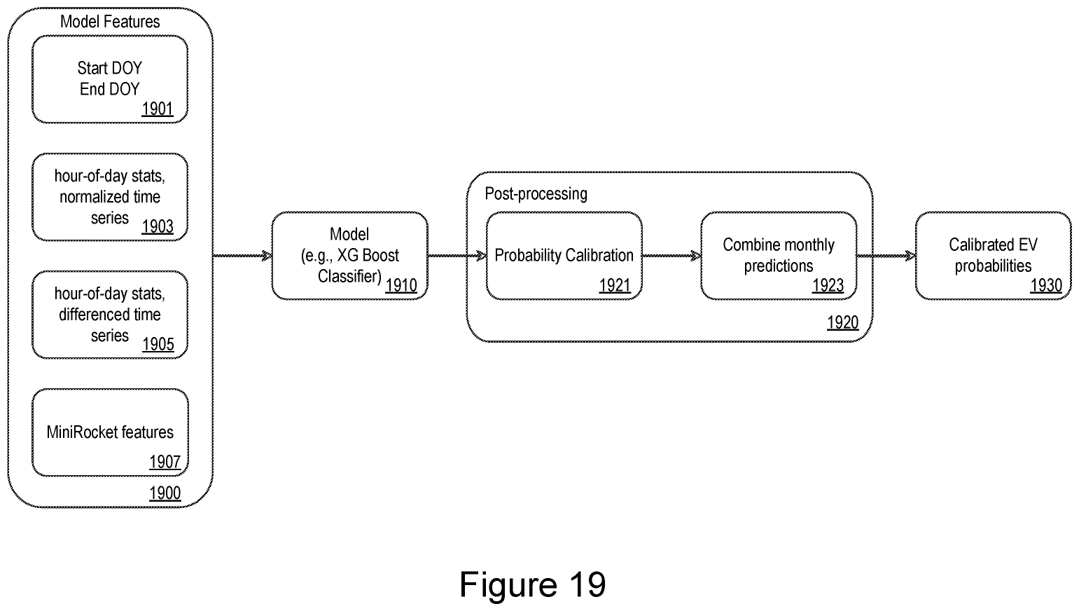

YES labeled values of the training population and the selected sub-set of the NO labeled values of the training population will be used as a reduced labeled training population to train the machine learning model. (Depending on the embodiment, the YES labeled values used at this point may be a portion of the YES user data, with others reserved for testing as described below, or may be all of the YES valued user data from a first population used from training and a separate population used for testing.) For training, a set of features of the training population data is used by the machine learning model. In the process described below in more detail with respect to FIG. 19, these features, including time series data features, are extracted from the training population at step 1711. The training of the machine learning model occurs at step 1713 using extracted features on the reduced labeled training population, labels, and, in some embodiments, telematics. A number of different models can be used. For example, the machine learning model can be a Histogram-based Gradient Boosting Classification Tree, or other models such as a random forest model. For feature selection, a similar XG Boost Classifier, for example, can be used for deciding which features are important, and throwing out unimportant features to improve model performance.

The performance of the trained model is measured at step 1717. As noted above with respect to step 1709, the model is trained using a reduced labeled training population in which the number of YES labeled user locations and the number of non-YES labeled (i.e., NO or unlabeled) user locations are of a similar or comparable size (i.e., roughly equal, such as within a factor of two), with only a small subset of the non-YES labeled households of the larger training population used. The performance of the trained model can be measured using a labeled test population, where this can be part of the user locations and corresponding labels of steps 1701 and 1703, or a different set of labeled user locations. The test population can be used to determine whether the trained model is accurate on a more realistic situation where the proportion of non-YES valued user locations is larger than was the case for the reduced training population. The electricity usage data of the customer locations can be input into the trained model, assigned labels by the model, and these model-assigned labels can be compared against the corresponding labels received with the test data. In some embodiments, the performance could be measured using multiple test populations with increasing proportions of the non-YES labeled data included, such as a first test with an intermediate proportion of the non-YES labeled test population followed by a second test population that uses all of the non-YES labeled test population.

The training population and testing populations are distinct. For example, in one set of embodiments the data used for training and the data used for testing (both usage data and labels) may be received as part of a single data set from which a training population and testing population can be constructed. For example, the YES labeled data can be dividing up into a test population subset of, for example, 20% and the other 80% going into the training population. Enough non-YES labeled user locations are chosen to a get a training population that is balanced between YES and non-YES user locations or only slightly imbalanced, such ˜2:1 for non-YES to YES subsets. For the test population, the test populations of YES labeled user locations are combined enough non-YES user locations to get a desired concentration of YES labels in the test population, where, as noted above, the testing can be done for a single test population or multiple test populations of differing concentrations. In one embodiment, at least one test population uses a concentration set to be at or near the expected actual concentration of the entire population of the utilities user base. If a desired concentration in the test population is quite low (e.g., ˜1%), in some embodiments the concentration can be padded out by oversampling randomly selected NO labeled user locations.

Based on the measured performance, the accuracy of the model is determined by step 1717. In terms of reporting out performance to a utility, the test using the concentration set to be at or near the expected actual concentration of the entire population of the utilities user base can be used. Model performance can be measured using a variety of machine learning metrics. As discussed below in more detail, the measurement can use precision, recall, and a combination of those two metrics. If the model performance is low and does not pass the determination step 1717, the flow can loop back to be re-, or further, trained. For example, the training can use new or different features, use a different filtering of the labeled data to generate a reduced labeled training population, change the feature selection, use a different machine learning mode, or make other changes. If the trained model passes at step 1717, it can then continue on to making predictions on the unlabeled data population.

A second set of usage data, or inference data, for customer locations is then received at step 1719, where this data will again be over an extended time period, where this can be the same extended time period as for the training population as in step 1701, another time period of the same duration, or a time period of another duration. In an example embodiment, this can again be a year interval as in the case of the training population. This second set of usage data for customer locations is unlabeled (or unreliably labeled) and the trained machine learning model is then used on it at step 1723 for EV detection, thereby establishing a label on whether or not the user location is used for charging an EV or EVs. Additionally, as discussed in more detail below, some embodiments can provide a confidence level for the determined household labels. In some embodiments, a determination of the portion of a households total electricity usage that is EV usage, or disaggregation, can be determined by model, where, in some embodiments, telematics data or other EV usage data from EVSEs can be incorporated into the determination. In embodiments that do perform disaggregation, at step 1721 telematics data is received for EVs corresponding to the customer locations in the second usage data set (the inference population).

The generated label and corresponding confidence are determined at step 1723, these data values can be provided to the utility at step 1725. This data can be useful to a utility for things such as planning and management of a distribution network and for marketing directed at EV users, among other purposes. If disaggregation data on EV usage is also included, this can be used for differential billing for EV electricity usage or grid planning, for example. The disaggregation is performed using, for example, the telematics data or other EV usage data from EVSEs at step 1727. Additionally, for user locations determined to have a label indicating one or more EVs charging there, the trained model can extract EV charging patterns from the inference data at step 1727. The charging pattern information can be provided to the utility so that it can use the more detailed information on EV usage patterns in distribution network management. If an EV or EVs are detected at a customer location, at step 1729 charging schedules can then also be generated for the EVs as described above.

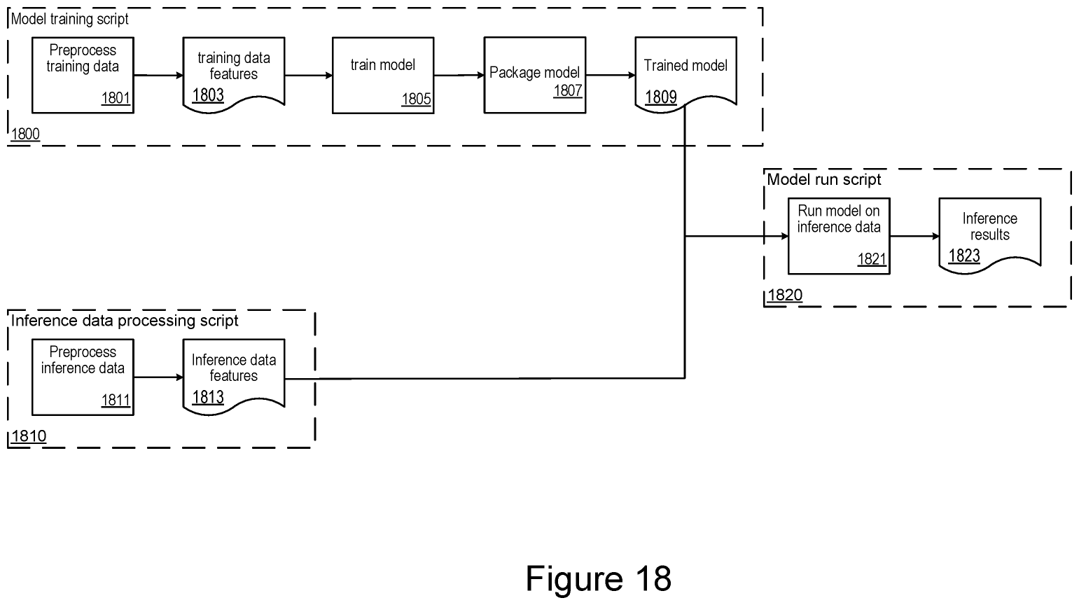

Considering some of the aspects described above with respect to FIG. 17 in more detail, FIG. 18 illustrates the relationship between different parts of an embodiment for the EV detection application. Many of the elements of FIG. 18 correspond to particular steps of FIG. 17, but are arranged differently to highlight the relationship of the different processes.

The model training script 1800 uses the training data to train and test the EV detection model based on the usage data, such as year of historical AMI data for all service points in the training set, and label values, indicating that an EV charges at a service point or does not (or at least is not known to) charge at the service point. As discussed above with respect to steps 1701, 1703, and 1707, the label data can come from a utility, derived from telematics, from other sources or combinations of these. In some embodiments, additional data from the telematics may be incorporated into the training data. Preprocessing of the training data 1801 can correspond to step 1705. Preprocessing can include dropping unphysical usage values (overly high or negative values, for example), interpolating small gaps in data, splitting the data into smaller time segments (such as a “standardized month” of the 28-day intervals illustrated in the data of FIGS. 16A-16C), and other preprocessing. Training data features 1803 can correspond to step 1711 and is further discussed below. The model training 1805 on the reduced training data set can correspond to step 1713, as well as including steps 1715 and 1717. The model can then be packaged at 1807 and the trained model 1809 saved as a file.

The inference data processing script 1810 is used on the data used to generate the EV predictions based on usage data, such as on a year of historical data for all service points in the utility territory (excluding those in the training set). Preprocessing of inference data 1811 and extraction of inference data features 1813 can be performed similarly to 1801 and 1803, respectively. (1811 and 1813 are not explicitly represented in FIG. 17, but can be considered part of step 1723.) The trained model 1809 and inference data features 1813 can then be used by the run model script 1820, with the model run on inference data 1821 (corresponding to step 1723) to generate the inference results 1823, which can then be provided to the utility as in step 1725.

FIG. 19 provides more detail on an embodiment for the model architecture and its features of the training data features 1803 and inference data features 1813. In this example embodiment, the model features include the start day of year (DOY) and end day of year 1901 for the usage data, although other embodiments can be used to capture the time of year and seasonal variations for the smaller time segments. As noted above, both the training data and inference data, such as AMI data, is for an extended time period such as a year. By having data for such an extended period and also its start and end dates, seasonal effects on the AMI values (e.g., heavier electricity usage due to air conditioning) can be captured.

Other features can include hour-of-day statistics, both as a normalized time series 1903 and as a differenced time series 1905, where other embodiments can use other intervals than an hour. In the normalized time series 1903, the median usage is subtracted from all of the time values. In the differenced time series 1905, the absolute difference from the previous hour's usage is computed. For each hour, statistics can be computed, where EV charging can manifest itself in tails of normalized/differenced time series distributions. Another example of the model features are “MiniRocket” features 1907, which is an example of a fast and accurate time series classifier that can capture different features' shape changes in a time series on different time scales based on convolution kernel transformation, somewhat analogous to a Fourier transform. These features are just examples and, depending on the embodiment, a number of alternate or additional features for computing statistics of usage values can be used.

The model features can then serve as inputs to a model 1910, such as a gradient boost type (e.g., Gradient boosting classifier) classifier or other machine learning model. For example, the model can use a series of weak learners, or decision trees, with additional trees added in sequence with each new tree attempting to fix the poorest predictions made by the previous trees. The output of the model 1910 will be classifier output values ranging from 0 to 1, where a value at or close to 0 corresponds to a NO EV prediction and a value at or close to 1 corresponds to a YES EV prediction. These “raw” classifier values will generally not provide a 1:1 linear relationship of classifier output values versus the fraction of positives. To turn these values into a true probability (i.e., 50% of customer locations with a probability of 0.5 will have an EV), in post-processing 1920 the raw classifiers can be normalized by the probability calibration step 1921. As noted above, data for the extended time interval, such as a year, can be broken up into smaller time segments, such as 28-day intervals, for processing. These monthly predictions can then be combined at 1923, putting more weight on predictions from more recent 28-day segments, accounting for large changes in predictions over time (such as to a move or a new EV purchase), and removing outlier values, for example. The combined per-segment prediction probabilities for a given household can provide a single value to represent the probability that at-home EV charging has occurred at the end of the full time interval spanned by the data. In the case that earlier segments' probabilities are significantly higher or lower than later segments, that the change occurs suddenly, and that later segments' probabilities are stable over time, it can be assumed that a qualitative change in at-home EV charging has occurred, such as a move or EV purchase In other cases, out any outlier per-segment prediction probabilities can be filtered out (due to a period of charging inactivity because of a vacation, for example), and then the remainder can be combined using an exponentially weighted moving average that puts higher weight on more recent segments' values. The end result is the calibrated EV probabilities 1930.

Considering the model performance determination of step 1715, one embodiment for determination of model can be based on a combination of “precision” and “recall”. The quantifying of a binary prediction model, as is the case for EV detection, can be based on false/true positives/negatives, where these are: a false positive, where a EV is detected when there is none; a false negative, where an EV is not detected when there actually is one; a true positive, where a EV is detected and these is one; and a true negative, where an EV is not detected and there is none. The measures of recall and precision and be defined as:

recall=true positives/(all “real” positives)=true positives/(true positives+false negatives),
so that a recall of 80%, for example, would mean that of all the households that have an EV, the model correctly identified 80% of them as having an EV; and

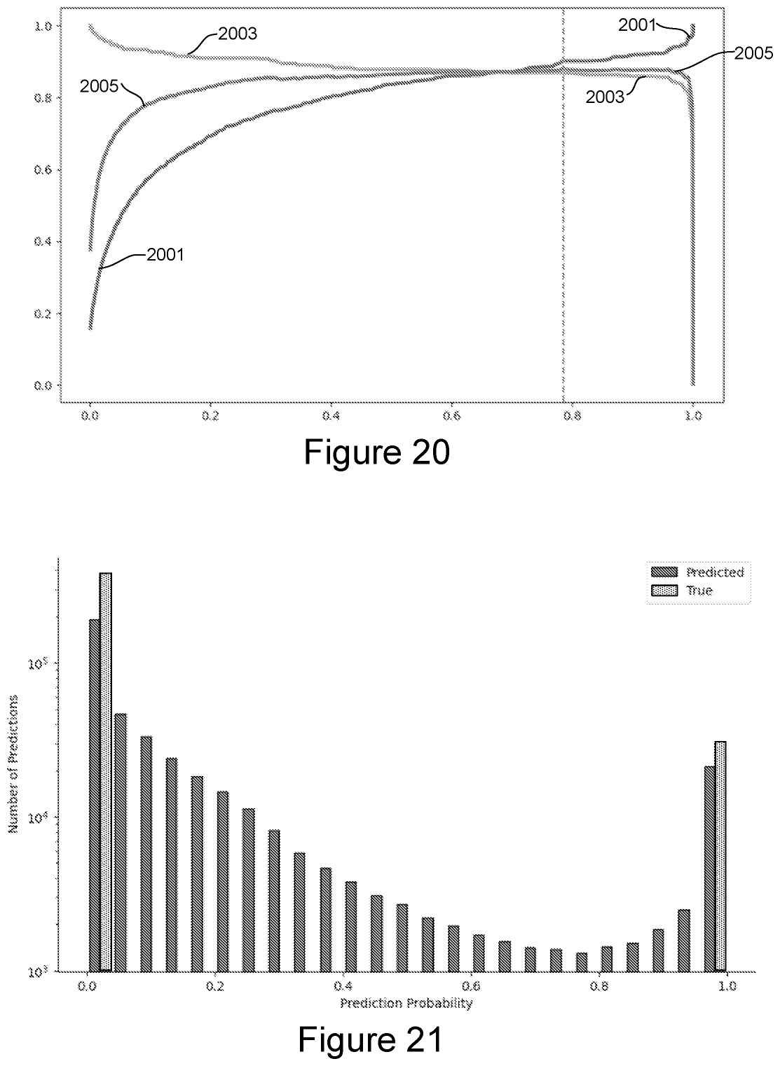

precision=true positives/(all predicted positives)=true positives/(true positives+false positives),
so that a precision of 80%, for example, would mean that of all the households that were predicted to have an EV by the model, 80% of them actually have an EV. In one set of embodiments, a combination of recall and precision can be used, as is illustrated with respect to FIG. 20.

FIG. 20 illustrates model performance based on precision 2001, recall 2003, and a combination of these 2005. In this example, the combination 2005 is a weighted combination of precision 2001 and recall 2003, with recall weighted somewhat more heavily (e.g., by a factor of ˜1.5) than precision. The vertical axis corresponds to the values of precision 2001, recall 2003, and the combination 2005 and the horizontal axis is the calibrated probability determined by the model for the customer location. If, in the decision of step 1717, a threshold value of ˜0.8 (the broken vertical line) is used, for example, this provides a high performance of ˜90% precision and recall. Additionally, the flatness of the combination 2005 across most of the range means that very few households will have uncertain classifications.

As illustrated in FIG. 20, setting the threshold determines the performance of the model, where in this example the threshold based on the precision-recall that gives the maximum value of the combination 2005, but more generally a number of other metrics can be used. More generally, a metric can be chosen based on the intended use of detection process and the threshold selected based on a value that gives the best performance. For example, when the primary use is for marketing, recall is more important than precision, which is why a metric can be chosen that weights recall over precision slightly.

FIG. 21 is histogram of the predictions for a given prediction probability, corresponding to the confidence values of step 1725. The binary values of either 1 or 0 corresponding to the prediction of whether or not an EV charges at a customer location for the population are shown in the stippled bars, where, as the number of values are shown in a logarithmic scale, the 0 (i.e., NO) values are around 10 times the 1 values. The prediction probabilities are shown as solid bars. Again noting the logarithmic vertical scale, the prediction probabilities are highly stratified to values near 0 and 1, with the number of predictions rapidly dropping off as the probabilities move away from either the 0 or 1 values. This demonstrates that the model is highly confident in the vast majority of its predictions: prediction probabilities close to 0 mean that there is a very small probability of an EV at that household (that is, a very large probability of no EV at that household); conversely, prediction probabilities close to 1 indicate that there is a very high probability of an EV at that household. Note that the total sample counts of the prediction probabilities and the binary 0 (“no EV”) or 1 (“has EV”) predictions are equal, as every prediction probability is converted to a binary prediction using the threshold value discussed above.

Considering now step 1727 and disaggregation, the household's usage data from step 1719 gives a measure of the total energy delivered to customer location from the grid, where, based on AMI data this information can be for 15 minute intervals, for example. The goal of an EV disaggregation model is to compute how much of that delivered energy went to EV charging at the location. For example, referring back to FIGS. 3-5, the spikes such as at 301/401 or 303/403 represent the EV charging contributions above the underlying non-EV usage at the set of households. The telematics data (such as from EVSEs, OEMs, or the EVs) of step 1721 can be useful in the disaggregation process. Depending on the embodiment, there can be different kinds of EV disaggregation models that can be built.

In a first embodiment of a disaggregation model, EVSE or other telematics data are available from the EVs that charge at the customer locations. This model would only attempt to disaggregate EV charging energy consumption from total household energy consumption for households where telematics data are available from the EV. The purpose of this model would be to improve the quality of charging energy consumption data obtained from telematics alone. That data can be of varying quality. For example, some EVs do not report exact data on charging, but only report the battery level in a charge percentage. In some cases, telematics data will be incomplete data due to loss of communication with the vehicle. By combining this data with the AMI data, more accurate values for the EV energy consumption can be extracted.

In another embodiment of a disaggregation model, EVSE or other telematics data can be used to train the model, but then run the model on houses where telematics data is unavailable. This process can be considered a combined detection and disaggregation model, so the model could predict the detection of an EV, when it is charging, and how much energy it consumed. The accuracy of these predictions may not be as good as the model when telematics data are available because, for that model, there are two independent measurements of the charge events. However, this second model embodiment can be useful for cases that do not require very high-accuracy predictions, such as for grid protection, where the utility may only need an approximate measure of how much energy and when a driver is charging, so that the utility can plan and manage the grid around that information.

The disaggregation can be useful to both the utility and the scheduling aspects discussed above with respect to FIGS. 7-14. In the discussion above with respect to scheduling, the information on the amount of energy delivered from the grid to the different EVs charging on the grid can be of varying quality, where some sources (i.e., OEMs) provide fairly accurate data, while others provide data of lower accuracy. The ability to perform disaggregation on each and every observed event allows a load managing application to have much more accurate vehicle load profiles. This additional information could, for example, ensure that the load manager did not claim that the energy delivered to a vehicle during some time period is larger than the total energy delivered to that house during the same period. Additionally, this could allow a load manager to provide very accurate vehicle load profiles, which could be for billing purposes, for example.

For EVs not enrolled in the scheduling program, the disaggregation information of step 1727 can be used to generate more detailed information about user's EV charging behavior at points on the distribution gird beyond that available from EV detection, such power that the individual EVs are charging and frequency of charging, that can be used for distribution planning. In this way, the disaggregation data for unregistered EVs can be used as a substitute for telematics or EVSE data. Such information can allow a utility or load manger application to manage around un-enrolled EVs.

According to a first set of aspects, a method includes: receiving first electricity usage data values for a training population of a plurality of user locations over a first multi-month time period, the first electricity usage data values having a temporal resolution of multiple intervals per day; and receiving for a plurality of the training population's user locations a corresponding label indicating whether an electrical vehicles (EV) uses the user location for charging. The method also includes: selecting, from user locations not having a corresponding label indicating that an EV uses the user location for charging, a first subset of the training population; extracting features, including time series data features, from the first electricity usage data values for the training population; training a machine learning model using the extracted features on the first electricity usage data values and corresponding labels of the first subset of the training population and the user locations of the training population having a label indicating that an EV uses the user location; receiving second electricity usage data values for an inferencing population of a plurality of user locations over a second multi-month time period; and determining, by the trained model from the second electricity usage data values for the inferencing population, a label for each of the user locations of the inferencing population indicating whether or not an EV uses the user location for charging and a corresponding confidence value for each of the label for each of the user locations of the inferencing population.

In additional aspects, a system includes one or more interfaces and one or more processors connected to the one or more interfaces. The one or more interfaces are configured to: receive first electricity usage data values for a training population of a plurality of user locations over a first multi-month time period, the first electricity usage data values having a temporal resolution of multiple intervals per day; and receive for a plurality of the training population's user locations a corresponding label indicating whether an electrical vehicles (EV) uses the user location for charging. The one or more processors are connected to the one or more interfaces and configured to: select, from user locations not having a corresponding label indicating that an EV uses the user location for charging, a first subset of the training population; extract features, including time series data features, from the first electricity usage data values for the training population; train a machine learning model using the extracted features on the first electricity usage data values and corresponding labels of the first subset of the training population and the user locations of the training population having a label indicating that an EV uses the user location; receive second electricity usage data values for an inferencing population of a plurality of user locations over a second multi-month time period; and determine, by the trained model from the second electricity usage data values for the inferencing population, a label for each of the user locations of the inferencing population indicating whether or not an EV uses the user location for charging and a corresponding confidence value for each of the label for each of the user locations of the inferencing population.

Further aspects include a method, comprising: receiving first electricity usage data values for a training population of a plurality of user locations over a first multi-month time period, the first electricity usage data values having a temporal resolution of multiple intervals per day; receiving for a plurality of the training population's user locations a corresponding label indicating whether an electrical vehicles (EV) uses the user location for charging; receiving telematics data for EVs that charge at the one or more user locations of the training population, wherein the machine learning model is further trained using the telematics data; training a machine learning model on the first electricity usage data values and corresponding labels of the first subset of the training population and the user locations of the training population having a label indicating that an EV uses the user location; receiving second electricity usage data values for an inferencing population of a plurality of user locations over a second multi-month time period; determining, by the trained model from the second electricity usage data values for the inferencing population, a label for each of the user locations of the inferencing population indicating whether or not an EV uses the user location for charging; and disaggregating by the trained machine learning model of the EV electricity usage from total electricity usage for one or more user locations of the inferencing population.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

What is claimed is:

1. A method, comprising:
receiving first electricity usage data values for a training population of a plurality of user locations over a first multi-month time period, the first electricity usage data values having a temporal resolution of multiple intervals per day;
receiving for a plurality of the training population's user locations a corresponding label indicating whether an electrical vehicle (EV) uses the user location for charging;
selecting, from user locations not having a corresponding label indicating that an EV uses the user location for charging, a first subset of the training population;
extracting features, including time series data features, from the first electricity usage data values for the training population;
training a machine learning model using the extracted features on the first electricity usage data values and corresponding labels of the first subset of the training population and of the user locations of the training population having a label indicating that an EV uses the user location;
receiving second electricity usage data values for an inferencing population of a plurality of user locations over a second multi-month time period; and
determining, by the trained model from the second electricity usage data values for the inferencing population, a label for each of the user locations of the inferencing population indicating whether or not an EV uses the user location for charging and a corresponding confidence value for each of the label for each of the user locations of the inferencing population.

2. The method of claim 1, wherein the first electricity usage data and second electricity usage data is advanced metering infrastructure (AMI) data.

3. The method of claim 1, wherein one or more of the corresponding labels for the training population's user locations is received from a utility.

4. The method of claim 1, wherein one or more of the corresponding labels for the training population's user locations are electric vehicle supply equipment (EVSE) data.

5. The method of claim 1, wherein receiving the corresponding label for the training population's user locations comprises:
receiving telematics data for the training population's user locations; and
determining the corresponding labels from the telematics data.

6. The method of claim 1, wherein a number of user locations having a label indicating that an EV uses the user location for charging is sparse in the training population of user locations.

7. The method of claim 6, wherein the first subset of the training population is of a comparable size to the number of user locations having a label indicating that an EV uses the user location for charging.

8. The method of claim 1, wherein the first multi-month time period and the second multi-month time period both are at least a year.

9. The method of claim 1, wherein the first electricity usage data values have a temporal resolution of intervals of an hour or less.

10. The method of claim 1, where the corresponding labels indicating whether an EV uses the user location for charging include a first value, indicating that an EV uses the user location for charging, and a second value, indicating either that an EV does not use the user location for charging or that it is unknown whether an EV uses the user location for charging.

11. The method of claim 1, wherein the user locations include households.

12. The method of claim 1, wherein the machine learning model is a gradient boosting type model.

13. The method of claim 1, wherein the time series data features include hour-of-day statistics.

14. The method of claim 1, further comprising:
providing the determined labels for the user locations of the inferencing population and corresponding confidence values to a utility.

15. The method of claim 1, further comprising:
prior to training the machine learning model, making a determination of user locations of the training population for which the corresponding label is inaccurate; and
removing from the training population locations for which the corresponding label is determined inaccurate.

16. The method of claim 1, further comprising:
subsequent to training the machine learning model and prior to determining the label for each of the user locations of the of the inferencing population, measuring performance of the trained machine learning model; and
in response to determining that performance of the trained machine learning model is low, re-training the machine learning model.

17. The method of claim 16, wherein the performance of the trained machine learning model is measured using a combination of precision and recall.

18. The method of claim 1, further comprising:
receiving telematics data for EVs that charge at the one or more user locations of the inferencing population; and
for the one or more user locations of the inferencing population for which telematics data is received, disaggregating EV electricity usage from total electricity usage.

19. The method of claim 18, wherein the telematics data includes electric vehicle supply equipment (EVSE) data.

20. The method of claim 1, further comprising:
receiving telematics data for EVs that charge at one or more user locations of the training population, wherein the machine learning model is further trained using the telematics data; and
disaggregating by the trained machine learning model of the EV electricity usage from total electricity usage for one or more user locations of the inferencing population.

21. The method of claim 20, wherein the telematics data includes electric vehicle supply equipment (EVSE) data.

22. A system, comprising:
one or more interfaces configured to:
receive first electricity usage data values for a training population of a plurality of user locations over a first multi-month time period, the first electricity usage data values having a temporal resolution of multiple intervals per day; and
receive for a plurality of the training population's user locations a corresponding label indicating whether an electrical vehicle (EV) uses the user location for charging; and
one or more processors connected to the one or more interfaces and configured to:
select, from user locations not having a corresponding label indicating that an EV uses the user location for charging, a first subset of the training population;
extract features, including time series data features, from the first electricity usage data values for the training population;
train a machine learning model using the extracted features on the first electricity usage data values and corresponding labels of the first subset of the training population and the user locations of the training population having a label indicating that an EV uses the user location;
receive second electricity usage data values for an inferencing population of a plurality of user locations over a second multi-month time period; and
determine, by the trained model from the second electricity usage data values for the inferencing population, a label for each of the user locations of the inferencing population indicating whether or not an EV uses the user location for charging and a corresponding confidence value for each of the label for each of the user locations of the inferencing population.

23. A method, comprising:
receiving first electricity usage data values for a training population of a plurality of user locations over a first multi-month time period, the first electricity usage data values having a temporal resolution of multiple intervals per day;
receiving for a plurality of the training population's user locations a corresponding label indicating whether an electrical vehicle (EV) uses the user location for charging;
receiving telematics data for EVs that charge at the one or more user locations of the training population, wherein the machine learning model is further trained using the telematics data;
training a machine learning model on the first electricity usage data values and corresponding labels of the first subset of the training population and the user locations of the training population having a label indicating that an EV uses the user location;
receiving second electricity usage data values for an inferencing population of a plurality of user locations over a second multi-month time period;
determining, by the trained model from the second electricity usage data values for the inferencing population, a label for each of the user locations of the inferencing population indicating whether or not an EV uses the user r location for charging; and
disaggregating by the trained machine learning model of the EV electricity usage from total electricity usage for one or more user locations of the inferencing population.
